(19) United States
(12) Patent Application Publication
(10) Pub. No.: US 2007/0294170 A1
(43) Pub. Date: Dec. 20, 2007

(54) Systems and methods for conditional access and digital rights management

(76) Inventors: Luc Vantalon, Sunnyvale, CA (US); Paolo L. Siccardo, Los Altos, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/446,427

(22) Filed: Jun. 2, 2006

(51) Int. Cl. H04L 9/00

(52) U.S. Cl. 705/50

(57) ABSTRACT

Conditional access (CA) and digital rights management (DRM) in digital media delivery, processing, and storage systems. Methods and apparatuses are provided for managing digital rights under the protection of multiple CA and/or DRM systems. Some embodiments provide secure and robust methods for bridging multiple DRM systems in the digital media content distribution and playback systems. The present invention simplifies content delivery, conditional access, and digital rights management.

### BACKGROUND OF THE INVENTION

1. Field of the Invention

The present invention generally relates to digital media delivery and management systems. More particularly, the present invention pertains to systems for digital rights management.

2. Description of the Related Art

Digital media usually refers to some form of electronic media that can be manipulated by digital processing systems in one way or another. Unlike analog media, digital media is typically transmitted, stored, and/or processed in digital forms, e.g., in binary formats.

Use of digital media has been gaining popularity over the last few decades partly due to their technical advantages over the analog counterpart, such as robustness over noise, and partly due to the wide availability of various digital information processing systems such as personal computers and CD or DVD players. Digital media are generally easier to process and/or manage and they are often considered to have higher perceptual qualities. Digital broadcasting has also been gradually gaining momentum in the cable and satellite television or radio industries. Moreover, terrestrial digital television (DTV) broadcasting has been tentatively scheduled to supersede analog television by early 2009 in the United States.

The better processing capability of digital media is, however, also one of the downsides of using digital media. For example, digital media, or more precisely digital data associated with digital media, can be reproduced indefinitely without any loss of quality, often with no or very little cost. Furthermore, it can be easily altered or modified or copied in part or in whole without any accountability. This has been a hindrance to wide-scale adoption of digital media in many potential application areas. This is especially true for copyrighted media, or media that otherwise need to be protected for transmission, access, or reproduction. In many cases, the user needs special rights or permissions in order to be able to perform certain tasks or operations associated with a digital media. This is often referred as digital rights. The term digital rights sometimes refers to legal rights associated with the digital media. It sometimes refers to technical rights or capabilities, and it may not necessarily coincide with the rights' holder's legal rights.

A digital rights management (DRM) system manages digital rights and also rights of other types of media. Many digital media publishers and vendors use DRM systems to protect copyrighted or otherwise access-controlled materials. Typical DRM systems use various technical measures to identify, describe, analyze, valuate, trade, monitor, and track digital rights. For example, DRM systems often use copy protection measures to control and/or restrict the use and access of digital media content. In the commercial context, DRM provides a method to control any duplication and dissemination of digital media so that appropriate fees can be collected, for example, for each copy or for each performance of the media content.

A typical DRM system uses encryption and decryption software for this purpose along with other software or hardware based security measures. For example, DVD movies are encrypted, or scrambled, using Content Scrambling System (CSS) by DVD Forum. The data on the DVD is encrypted, in addition to being compressed or encoded in MPEG-2 format, and it may only be decrypted and viewed using one or more valid decryption keys. In a typical DRM scheme, a DRM server wraps the digital content through encryption according to applicable policies.

Once the digital media is delivered, a DRM client unwraps the content and makes it accessible to the user in accordance with his or her rights. DRM clients may include desktop PCs, handhold devices, set-top boxes, mobile phones and other portable devices as well as other dedicated digital media players (e.g., for music, movies, etc.) and television and radio sets. The digital rights are typically distributed to clients separately from the wrapped media content. They can be distributed at the time of the content distribution, or they can be dynamically accessed later when needed, for example, at the time of storage or playback.

In the cable industry, and in other related industries such as satellite broadcasting, media is protected by conditional access (CA) systems. CA refers to a technique for limiting the access of protected content to authorized users. In a typical CA system such as those used in the cable television industry, the scrambled media content is delivered along with a decryption key called a control word (CW). The control word is embedded in an encrypted message called ECM (entitlement control message), which can be decrypted using another key called a service key (SK). The service key is delivered to the user in a different message called EMM (entitlement management message), and it may be unlocked using a user-specific decryption key, or user key (UK), which is typically associated with a client device, either at hardware or firmware level, such as a “smartcard”. The lifetime of each key varies depending on the purpose, and it varies from application to application. Typically, the lifetime of CW is much shorter (on the order of 0.1 second for live video stream) than that of SK, which is, for example, on the order of a month or so for a subscription channel in the cable television. SK and CW can also be associated with a particular media, for example, a movie title for pay-per-view. The UK is usually permanent, but can be replaced by providing a new smartcard to the user. Typical CA systems also have the ability to “revoke” UKs from unauthorized devices. It should be noted that a CW is not generally user specific. Using the (subscriber-specific) SK, the system can securely broadcast other common information, such as the CWs or the media content, to subscribers simultaneously without having to broadcast a different program for each of the subscribers.

The digital media content (e.g., video and audio signals) of one program, typically in the MPEG-2 format in the case of cable television, is sometimes multiplexed together with those of other programs for transmission so that multiple programs appear to be transmitted simultaneously. A CA system scrambles the digital form of programs and transmits the entitlement control messages and the entitlement management messages with the digital form of programs for broadcast either within the multiplex (e.g., for satellite) or through an out-of-band channel (e.g., for cable).

Content encryption is typically done using symmetric key cryptography, while key encryption is typically done using public key/private key cryptography. In symmetric key cryptography, the same or essentially equivalent keys are used to both encrypt and decrypt the data. In the asymmetric or public key cryptography, different but related keys are used to encrypt and decrypt the data. Public keys may be derived from the corresponding private keys in certain cryptographic schemes, but not vice versa. In general, encryption/decryption schemes based on symmetric key cryptography are less expensive than those using asymmetric key cryptography in terms of computational requirements.

Typically, a client device such as a set-top box (STB) at the receiving end descrambles the data stream and decodes the MPEG-2 data for viewing. A tuner portion of the STB receives the incoming signal, demodulates it and reconstitutes the transport stream, which contains multiple packets of information. The set-top box can de-multiplex the entitlement management messages and entitlement control messages and the media content. The data (e.g., service key and control word) contained in the entitlement management message and entitlement control message are used to descramble the encrypted programming content. The set-top box then decodes the MPEG-2 data and renders the content for viewing.

Some DRM systems can store content that are still protected by the operator CA system. In this mode, ready access to CA servers may be required to access protected digital media. For example, when the digital media is stored in a user's device, in order to play the stored media the user may need to obtain an access grant from the corresponding CA server, e.g., as a form of an ECM. The associated ECM, or a CW contained in the ECM, may also be downloaded at the time when the media content is delivered.

FIG. 1 illustrates an overall “architecture” of an exemplary CA+DRM system in a block diagram form. The figure shows two virtual zones or realms, one 102 associated with a conditional access server 106 and the other 104 associated with a digital rights management system (not explicitly shown in the figure). DRM systems may have their own servers. Or, alternatively, certain related CA servers may be used for various DRM purposes such as authenticating clients. DRM systems may also manage the digital rights associated with digital media through other methods. In this example, the DRM realm 104, shown as a broken-line box in the figure, is used to indicate a logical domain where a particular DRM is in effect. The CA server 106 typically resides across a network 108 from a client device 110, such as cable network, satellite network, wireless phone network, or the Internet. When a digital media is delivered to the client 110, either from the CA server 106 or from other digital media services, the client first needs to get proper permission or entitlement before it can play or display the delivered content. The permission is often delivered as ECMs (e.g., in cable television transmission) as stated earlier. In typical real-time digital media delivery systems such as cable television, the required ECMs are simultaneously delivered along with the digital media content. In the example shown in FIG. 1, the CA server 106 is responsible for various CA-related tasks and it provides necessary support to the authenticated client 110 for accessing digital media content which the client is entitled to. The client can play the media in real time and/or store it for later viewing. The figure shows a storage unit 112 within the DRM realm 104 associated with the client. It may be a part of the client device 110 in some cases. The digital media is typically stored in the storage unit in an encrypted/scrambled form, or in an otherwise protected form. In this example, the DRM system 104 is responsible for protecting the stored digital media. In order for a client device such as a media player 110 to have access to the content of the stored media, it needs to have proper permission, which is provided by the DRM system in case the client is legitimately entitled to certain operations on the digital media.

FIG. 2 illustrates various message or data types used in certain implementations of conditional access (CA) schemes. In particular, the figure shows an entitlement management message (EMM) 134, an entitlement control message (ECM) 140, and a scrambled content 146, along with various encryption/decryption keys, which are typically used in CA systems in the cable television industry. A client device (not shown in the figure) typically contains a security device 130 associated with a CA server (not shown), and the security device has a unique user key (UK) 132 to represent a subscriber. The security device 130 may be a smartcard. The user key 132 can be used to decrypt the entitlement management message (EMM) 134, which has the encrypted service key (SK) 138. The client, or the security device 130, performs the EMM decryption 136 using the user key 132 to recover the service key 138. The entitlement control message (ECM) 140, on the other hand, contains an encrypted control word (CW) 144. In typical operations, the client, or the embedded security device 130, further performs the ECM decryption 142 using the service key 138 to recover the control word 144. The scrambled content 146, that is, the digital media content encrypted with CW 144, can then be descrambled using the control word to generate the clear content 150. Typically, the CA server provides the control word to an authorized client to descramble the content, at 148. The descrambled, or clear, digital media content 150 can be either played on the client device or retained for further processing or for (temporary or permanent) storage. In many cases, however, the scrambled content 146 can be recorded, sometimes along with the ECM 140, for later use and it is protected by a copy protection (CP) system, a DRM system, or a different CA system. The DRM system manages the rights according to the information in the EMMs and/or ECMs.

It should be noted that encryption and decryption keys are symbolically represented by locks and keys, respectively, in FIG. 2 and in other drawings throughout this disclosure. Even though these two different symbols are used for consistency whenever possible, it should be understood that, in symmetric key cryptography, the same or essentially equivalent keys are used for both encryption and decryption operations whereas, in public key cryptography, encryption keys (i.e., locks) and decryption keys (i.e., keys) are different and, in particular, it may not be computationally feasible to derive decryption keys from the corresponding encryption keys. As noted earlier, in digital media delivery and management, content scrambling (e.g., encryption of digital media content) is typically done using (generally computationally cheaper) symmetric key cryptography, while key encryption (e.g., encryption of service keys) is typically done using (generally easier to exchange) public key cryptography.

Although FIG. 2 shows a particular encryption/decryption arrangement of a CA system, it is understood that different arrangements can be used as well. In general, the entitlement management messages are broadcast to individual devices to individually authorize entitlement and the entitlement control messages are typically broadcast to all devices to provide the common keys for descrambling the broadcast stream. A service key represents the entitlement recovered from the entitlement management message and a control word represents the key recovered from the entitlement control message for descrambling the media content. The descrambler of a digital television system uses standard algorithms, e.g., Common Scrambling for Digital Video Broadcasting (DVB-CSA) and Digital Encryption Standard (DES) for Advanced Television Systems Committee (ATSC) standard (conditional access system for terrestrial broadcast). The descrambler (e.g., 148 in FIG. 2) can be conveniently placed on any of the various components (e.g., a bridge, a renderer, or a storage) in a client device.

With respect to FIGS. 3A and 3B, exemplary scenarios are illustrated in which digital media content is delivered and protected by a CA server and/or a DRM system. In FIG. 3A, an access control device 172, which is typically a part of a client device (not shown in the figure), has a user key 174 to decrypt the entitlement management message 176, which contains an encrypted service key (SK), which in turn is used to decrypt the entitlement control message 178. ECM 178 contains the encrypted control word (CW). The scrambled content 180, which is encrypted by the control word, is then decrypted by the client device. The access control unit 172, or any component associated with the client device, with the appropriate rights descrambles the protected content 182 using the control word 184 and provides the content 186 to the user. The content can either be recorded and stored in a storage device for later viewing or it can be provided for real time use. The client device may directly record the original CA protected content (e.g., as illustrated in FIG. 3A), or record the descrambled content (possibly with a different encryption for DRM protection), or record the content with substitutive CA/DRM protection (e.g., encrypting with replacement entitlement control messages, or rescrambling using different control words, etc.).

In the scenario shown in FIG. 3B, the recovered control word 210 is protected by a DRM system (symbolically represented by a cryptographic key 208 in the figure). In this example, only a certain CA/DRM client, e.g., an access control device 202 with a user key 204, which has appropriate rights (e.g., having access to the decryption key 208) can descramble the DRM protected CW 206 to get the CW 210. Then the decrypted control word 210 is used to descramble the delivered or stored media content 212 to obtain the clear content 214 that is not encrypted/scrambled. The rights to the control word can be determined from the data in the EMM at the time of recording and/or at the time of playback. The control word can also be provided to the client in real time as the broadcast is received for immediate viewing.

In some cases, a CA server may provide entitlement valid only at playback time. For example, the system can allow the user to record (scrambled) programs that the user is not entitled to use at the time of recording. After the user obtains the required rights (e.g., through purchase of pay-per-view service, or by upgrading a subscription package, etc.), the user can then play back the recorded information at later convenient time. As stated earlier, the descrambled content and/or decrypted keys may be rescrambled/encrypted using a different scheme, such as the one based on a DRM system, before it is stored in a storage device.

In typical conditional access of a primary security system (e.g., digital TV or satellite TV), the control word, which is a global key, needs to change frequently (e.g., once every 0.1 second) to avoid key-sharing attack. However, to locally protect the recorded and stored content with a DRM system, a control word that is unique to the access control device does not need to change as frequently. For example, an entire recorded movie may be rescrambled using only one control word. It should be noted that different CA systems and DRM systems may have entirely different implementations of EMMs and ECMs but have similar or same descramblers for content protection (e.g., according to the ATSC Standard).

Multiple digital rights management systems can be used for protection of digital media, e.g., at the same time or alternately depending on the contexts. For example, the digital media owners such as movie studios and media delivery services such as cable companies might utilize different and separate DRM systems for the same digital media, or for different parts of the same media. Similarly, the same cable television company (e.g. Comcast Corp. of Philadelphia, Pa.) may use different CA systems for different contexts or for different domains. Digital rights management can also be implemented in a hierarchical fashion or in multiple domains. This is schematically illustrated in FIG. 4A, where three different DRM systems 238, 240, and 242 are shown. These three DRM systems are grouped into two DRM “domains”, 232 and 234. In this particular example, the digital media delivered from across the network 236 may first be protected by two DRM systems 238 and 240. For example, the first DRM system 238 may be managed by a cable company and the second DRM system 240 may be managed by a movie studio. In order for a user to play the delivered content, he or she may need to get proper access permission from either system, or from both systems, depending on the implementation. Suppose now that the digital media content has been played and stored for later viewing. In the exemplary scenario shown in FIG. 4A, the stored content might be protected by either (or both) of the two DRM systems 240 and 242. For example, DRM system 240 may be associated with a movie studio who has the ownership of the particular media content stored on the user's device and DRM system 242 may be associated with a certain content management device or software. In general, there may be multiple content distributors, multiple content owners, and/or multiple content players of the same digital media, each of which may have its own DRM or CA system.

Different DRM or CA systems can also be involved for protection of digital media at different stages of their delivery, processing, playing, and storage processes. For example, FIG. 4B shows an exemplary context where multiple CA and/or DRM systems are employed during delivery of digital media. The media is delivered from a CA server 262 to a client (e.g., a storage unit 278 in the figure), and it is initially protected by the same CA server in this example. The broken-line box 252 represents this “virtual domain” or zone in which the CA server 262 is responsible for enforcing proper access rules regarding the digital media. The figure shows three more virtual DRM domains, 254, 258, and 260, each of which is under the protection of a DRM system (not explicitly shown in the figure). When the digital media is passed from one DRM system to another DRM system, the media content (and its associated keys) may be descrambled/decrypted using the keys from one DRM system and rescrambled/encrypted using the keys from the next DRM system. In the example illustrated in FIG. 4B, the media under the protection of CA server 262 is descrambled, 264, and scrambled again, 266, in the DRM system 254. The media is then passed to the next DRM system 258, through descrambling 268 and scrambling 272, and again to the next DRM system 260, through descrambling 274 and scrambling 276. In this example, the scrambled digital media content is stored, 278, e.g., in a client device, and the last DRM system 260 is responsible for protecting the stored digital media. The DRM systems closer to the source of the digital media are typically more “global” than the ones closer to the sink or the client. In other words, the DRM system 258 of the figure, for example, is more “local” than the DRM system 254. Generally, there is a one-to-many relationship between a global or upstream DRM system and a local or downstream DRM system. It should be noted that, in this particular example, whenever the digital media passes the DRM system boundaries, the media is exposed in clear forms. For example, at a point labeled 270 in FIG. 4B, the media (and/or any associated security keys) has been descrambled by DRM system 254 but has not been scrambled by the next DRM system 258, and therefore the content (and/or any associated security keys) is exposed in an unprotected state. This can be a potentially vulnerable point in a system design involving multiple DRM systems such as the one shown in the figure.

This is further illustrated in FIG. 4C, in which a “bridge” between two DRM systems is shown. The content 282 is initially protected by the first (or “global”) DRM system (not shown in the figure), as indicated by the fact that the initial content 282 is scrambled with the first key, or control word, 284. In this exemplary process, the digital media content is first descrambled, 286, using the first key 284 and rescrambled, 292, with a different key 290. The resulting content 294 is then under the protection of the second (or “local”) DRM system (symbolically represented by the control word 290). As illustrated in the figure, the content is exposed in clear form, 288, during this transition. That is, the content 288 is not encrypted with either of the access control keys, 284 or 290, and it is not protected by either of the DRM systems.

In general, this problem occurs when a digital media is protected by multiple digital rights management systems (and/or conditional access systems). During the lifetime of the digital media, the media may be protected by one or more of these DRM systems at any given moment. As illustrated earlier, different DRM systems may be involved at different stages of media delivery and processing. Whenever the media crosses boundaries of different DRM systems, the whole system may become vulnerable and the media content may be exposed to unauthorized uses, as shown in connection with FIGS. 4B and 4C. There have been many attempts, in the related art, to address this issue of bridging multiple DRM systems in the digital media content distribution, storage, and access systems in a more secure way.

FIG. 5A shows a prior art known as transcrambling. Transcrambling is a hardware-based method for changing digital media protection between two different DRM systems. The transformation occurs entirely within a generally secure hardware device (e.g., in a single integrated circuit chip), which is schematically denoted as a rectangular box 302 in the figure. The digital media content 308 is initially scrambled with a control word 310 (“CW A”), which is also encrypted with a service key (“SK A”). Both the content and the control word are under the protection of the first DRM system (not explicitly shown in the figure). Once the content 308 is input into the transcrambler chip 302, it is first descrambled, at 304, using the (decrypted) control words 310, and it is rescrambled, at 306, using the (decrypted) control word 314 (“CW B”) of the second DRM system (not explicitly shown). Note that the control word 314 is under the protection of the second DRM system, as indicated in the figure by the fact that it is encrypted with a service key (“SK B”) from the second DRM system. The rescrambled content 312 is then transmitted out of the transformation unit 302 for further processing or storage. Since the DRM bridging occurs within a single chip, this method is considered relatively secure. In some designs, the chip is made “opaque”, and it is protected against reverse engineering using various means. However, this scheme is rather expensive since it requires manufacturing of integrated chips with specific dedicated functions. It also lacks flexibility since the hardware design is not easy to change.

FIG. 5B shows a prior art known as superscrambling. Superscrambling refers to a technique of recursively, or repeatedly, scrambling digital media content with control words of multiple DRM systems. The figure illustrates an exemplary superscrambling process with two control words, each of which is from a different DRM and/or CA system. More specifically, the figure illustrates a process of superscrambling a media content 332 with two control words, 334 and 346. Control word 334 and service key 338 (e.g., “local” keys) are associated with one DRM system (e.g., an “inner” or “local” system), whereas control word 346 and service key 350 (e.g., “global” keys) are associated with another DRM system (e.g., an “outer” or “global” system). The digital media content 332 is first encrypted, or scrambled, with the first control word 334, at 336, and a scrambled content 342 is produced. Likewise, control word 334 is encrypted with service key 338, at 340, and an ECM 344 is created. This pair of encrypted data is then encrypted again with the second control word 346, at 348. This generates a doubly scrambled (or, “superscrambled”) content 354, which is schematically shown in the figure to include the first scrambled media content 342 and the first ECM 344. The second control word 346 is also encrypted with the second service key 350, at 352, and a new ECM 356 is created. Then, this pair of encrypted data, 354 and 356, is delivered to clients, for example, through a distribution path similar to the one shown in FIG. 4B. Since the digital media content is doubly scrambled in this example, the content is never exposed in clear form during the transmission (e.g., while passing between the first and the second DRM systems). In particular, when the outer encryption layer (e.g., represented by the control word 346 in the scrambled content 354 of FIG. 5B) is removed, the content is still protected by the first DRM system, indicated by the fact that the content 342 is encrypted with the control word 334. It should, however, be noted that this prior art approach requires both DRM systems present both at the source (e.g., a server) and at the sink (e.g., a client device). This approach may not be feasible in many practical applications, especially when “global” keys may not be available on the second (e.g., “inner”) DRM system.

Another prior art called simulcrypt is illustrated next with respect to FIG. 5C. Simulcrypt is a method for encrypting data in multiple ways, e.g., using multiple keys, so that it can be decrypted with any of the corresponding decryption keys. In the example shown in the figure, which is described in the context of cable television content delivery, the digital media content 396 is scrambled with a control word 390, which is encrypted in two alternative methods. That is, the control word 390 is encrypted with two different service keys, as shown in the figure as two different ECMs, 382 and 384. Therefore, the decryption key 390 can be obtained from either ECM 382 or ECM 384, and a client who has access to either of the ECMs, 382 or 384, can recover the control word 390, either by decrypting, at 386, the ECM 382 or by decrypting, at 388, the ECM 384. As illustrated in the figure, once the control word 390 is recovered, the encrypted content 392 can be descrambled, at 394, to obtain the clear content 396.

FIG. 5D shows how a prior art known as common scrambling can simplify the ‘bridging’ process when relevant CA or DRM systems share the same content scrambling/encryption algorithm. In the example illustrated in the figure, two DRM systems (represented by ‘A’ and ‘B’) are employed at the bridge 422 to manage the digital rights associated with a digital media. Both DRM systems use the same scrambling algorithm, and in particular the same control word 420. The control word 420 can be recovered from an ECM 416 with proper permission (e.g., service key 414 of the first DRM system). At the bridge 422, the content 418a is not descrambled with the control word 420 but it is output as it is, i.e., as the same scrambled content 418b shown at the right-hand side of the figure. However, the control word 420 (“CW A”) is decrypted and then encrypted again using a different service key 415 from the second DRM server (ECM 424). The content is, therefore, not exposed in clear form in the bridge. It should be noted that this particular prior art method is only concerned with bridging of the keys but not contents and, as stated earlier, this bridging method can be used only when the two DRM systems use the same scrambling algorithms as in the case of common scrambling.

### BRIEF SUMMARY OF THE DESCRIPTION

The present invention pertains, in general, to methods and apparatuses for conditional access (CA) and digital rights management (DRM) in digital media delivery and management systems. According to an embodiment, systems and methods for conditional access and copy protection in multiple DRM and/or CA domains are provided. According to another embodiment, methods and apparatuses are provided for managing multiple DRM domains in the presence of one or more CA servers. Some embodiments provide methods and apparatuses for bridging multiple DRM systems, for bridging multiple CA systems, or for bridging a CA system and a DRM system, in the digital media content distribution systems. Some embodiments of the present invention also provide systems, methods, and apparatuses for managing digital rights in multiple DRM domains in the digital media content delivery and storage systems. Embodiments of the present invention simplify digital media content delivery, conditional access, and digital rights management.

According to an embodiment, a method is provided for a DRM server to “overscramble” digital media content for the purpose of facilitating and securing a DRM bridge operation in a downstream device when the original and the secondary DRM systems are using different content scrambling algorithms. The method comprises scrambling the digital media content with an inner control word using the content scrambling algorithm of a secondary DRM system and overscrambling the resulting media content with an outer control word using the content scrambling algorithm of the original DRM system, where both control words are secured by the original DRM system. In certain embodiments, both control words are encrypted with the same service key. Then, the overscrambled content and both encrypted control words are delivered to a client or a bridge, possibly with other messages which include, for example, entitlement for a particular client and/or for the delivered digital media. In some embodiments, the entitlement messages are delivered to the client in response to the client's request. In some cases, the encrypted controls words are delivered dynamically when the explicit request is made from the client, for example, at the time of storage or playback of the digital media. At the boundary between the two different DRM systems, the outer control word is decrypted and used to remove the outer scrambling layer and the inner control word is decrypted and re-encrypted by the secondary DRM system to be re-inserted in the released scrambled media content. In certain embodiments, the two DRM systems may use the same content scrambling algorithms but different schemes. For example, the content may be first scrambled using AES (Advanced Encryption Standard) in CBC (Cipher Block Chaining) mode, and then overscrambled based on AES in CTR (Counter) mode.

According to some embodiments of the present invention, the following operations are performed: (a) Receiving digital media content, an outer encryption key CW_{A}, and an inner encryption key CW_{B}, (b) Scrambling the digital media content with the inner and outer encryption keys to create AB-scrambled or overscrambled content, and (c) Securing the encryption keys, CW_{A} and CW_{B}, by the outer DRM system A (e.g., by encrypting them with another encryption key SK_{A} associated with the DRM system A). These encrypted keys and the AB-scrambled digital media content are then delivered to a client. In certain embodiments, these encrypted messages may be delivered at the same time, e.g., during the time of initial distribution for playback. Or, in certain embodiments, the scrambled content is delivered first and the necessary keys may be distributed upon request from the client.

In at least one embodiment, systems and methods are provided for managing digital rights associated with digital media which are under the protection of multiple DRM systems. Certain embodiments of the present invention also provide methods and apparatuses for bridging multiple DRM systems in the digital media content distribution and storage systems. In some embodiments, various methods are used to switch encryption keys between two different DRM systems. At least one inventive method comprises encrypting a control word for a secondary (“inner” or “local”) DRM system with a service key associated with the original (“outer” or “global”) DRM system. In certain embodiments, the service key used to encrypt the control word can be switched at the bridge to a different service key secured by the secondary DRM system. This process is called “key rotation” in this disclosure. According to an embodiment, a method is employed to rotate keys at a bridge between an original digital rights management system and a secondary digital rights management system, where the first and second DRM systems have a first/outer and second/inner service keys, respectively. The method comprises receiving an overscrambled digital media content, which is encrypted with both an inner control word and an outer control word, and receiving an encrypted message, which includes both control word encrypted with the outer service key from the original DRM system. The method further comprises decrypting the encrypted message using the first service key and generating a second encrypted message, which includes the inner control word encrypted with the service key of the secondary DRM system. In some embodiments, the service key is delivered to the bridge prior to, or concurrently with, the delivery of digital media content and/or the encrypted messages.

According to an embodiment of the present invention, a method for key rotation is performed by the following operations: (a) Receiving a first encryption/decryption key SK_{A} associated with a DRM system A, and two control words CW_{A} and CW_{B} encrypted with the encryption/decryption key SK_{A}, (b) Receiving an overscrambled digital media content with an outer scrambling layer based on CW_{A} and an inner scrambling layer based on CW_{B}, (C) Decrypting the encrypted control words using the key SK_{A} to obtain the control words CW_{A} and CW_{B}, (d) Removing the outer scrambling layer with CW_{A}, and (e) Encrypting the decrypted key CW_{B} with a new encryption/decryption key SK_{B} associated with a DRM system B. In this exemplary process, the digital media content is scrambled with the control word key CW_{B} and it is delivered to a client along with the encrypted key CW_{B} and optionally with other encryption/decryption keys. In some embodiments, these encrypted messages and the scrambled content may be delivered at the same time, e.g., during the time of initial distribution for playback. Or, in certain other embodiments, the scrambled content is delivered first and the necessary keys may be distributed later, for example, in response to requests from the client. In some embodiments, encryption and decryption operations may use different encryption and decryption keys.

In accordance with some embodiments, a method is provided for decrypting digital media content that is pre-protected by one digital rights management system for another digital rights management system. The method comprises receiving, by a client, overscrambled digital media content which is encrypted by an inner and an outer control words, where the outer control word is associated with the original DRM system and the inner control word will be used by a secondary DRM system, receiving both control words encrypted with a service key which is associated with the original DRM system, decrypting the control words with the service key, and descrambling the digital media content using the decrypted outer control words. In some embodiments, the service key is received prior to receiving the scrambled content. In some embodiments, the service key is received in an encrypted form and the client needs to have a proper permission such as having an authenticated user key in order to be able to decrypt the service key.

According to an embodiment of the present invention, a method for descrambling digital media content comprises the following operations: (a) Receiving a service key SK_{A} associated with a DRM system A, two control words CW_{A} and CW_{B} encrypted with the service key SK_{A}, and an overscrambled digital media content by both control words CW_{A} and CW_{B}, (b) Decrypting the control words CW_{A} and CW_{B} using the service key SK_{A} and rotating CW_{B} by re-encrypting with service key SK_{B}, and (c) Descrambling the outer layer of the overscrambled media content using the decrypted control words CW_{A}. In some embodiments, these encrypted messages and the scrambled content may be delivered at the same time, e.g., during the time of initial distribution for storage. Or, in certain other embodiments, the scrambled content is delivered first and the necessary keys may be distributed later, for example, at the time of playback.

According to at least one embodiment, a content protection system called DTCP is used in transmitting various messages including the digital media content. DTCP stands for Digital Transmission Content Protection and it is a standard for protecting digital rights during the transmission of digital media. The DTCP standard defines, among other things, a cryptographic protocol for protecting digital media content from illegal copying, intercepting and tampering as it traverses network interfaces such as IEEE 1394 (“firewire”), USB (Universal Serial Bus), and/or other IP-based networks. In an embodiment of the present invention, DTCP is used in the original DRM system for the outer-layer scrambling protection of the overscrambled digital media content. In another embodiment, Windows Media DRM, from Microsoft Corporation of Redmond, Wash., or Apple iTunes DRM, from Apple Computer, Inc. of Cupertino, Calif., is used for the inner-layer protection of the scrambled digital media content.

Many benefits are achieved by way of the present invention over conventional techniques. For example, the present invention provides for a secure and efficient method for bridging between two or more digital rights management (DRM) systems. Typically, the originating DRM server does not need to be aware of particular details of how the downstream DRM servers are operated, it does not need to carry the certificates and revocation lists of the downstream DRM systems required to authenticate and revoke the downstream DRM clients, and it does not need to be approved, certified or comply with the robustness and compliance rules of the downstream DRM systems. In some embodiments of the present invention, secure bridging may be accomplished even when relevant DRM systems use different content scrambling schemes. Additionally, the invention provides a process in which the media content is securely protected by at least one DRM system during bridging, e.g., by overscrambling the content at the source DRM system. Depending upon the embodiment, one or more of these benefits may be achieved. These and other benefits will be described further throughout the present specification.

Therefore, as summarized herein, the present invention provides, among other things, methods for managing multiple digital rights management (DRM) systems. Furthermore, some embodiments of the present invention provide systems and methods for bridging multiple DRM domains in digital media distribution and management systems. For purposes of this description, CA systems are considered a form of DRM systems. These and other embodiments, features, aspects, and advantages of the present invention will be apparent from the accompanying drawings and from the detailed description and appended claims that follow.

### BRIEF DESCRIPTION OF THE DRAWINGS

The present invention is illustrated by way of example and not limitation in the figures of the accompanying drawings, in which like references indicate similar elements and in which:

FIG. 1 shows an exemplary environment in which digital media is delivered and managed. It illustrates a typical CA-plus-DRM system for protecting digital rights.

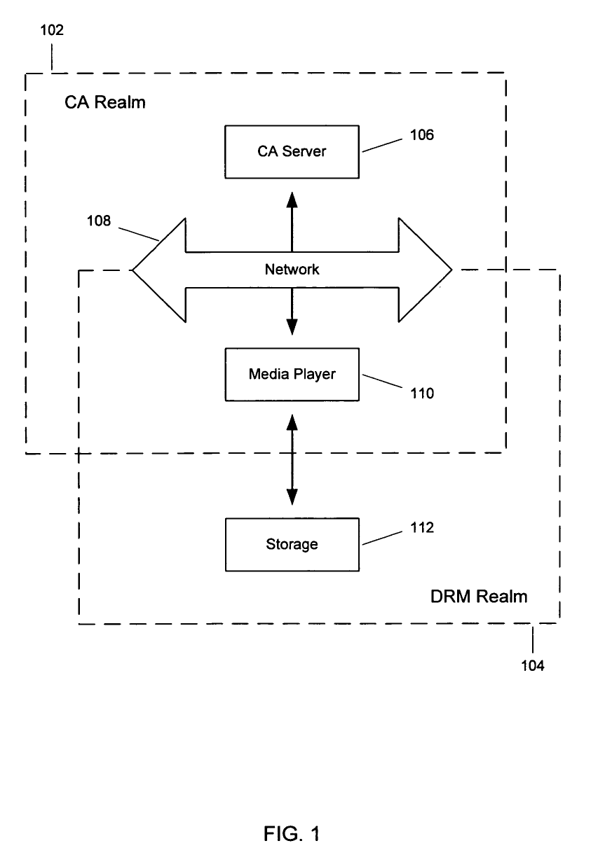

FIG. 2 illustrates various message types used in an exemplary conditional access (CA) system. It shows an entitlement management message (EMM), an entitlement control message (ECM), and a digital media content scrambled with a control word (CW).

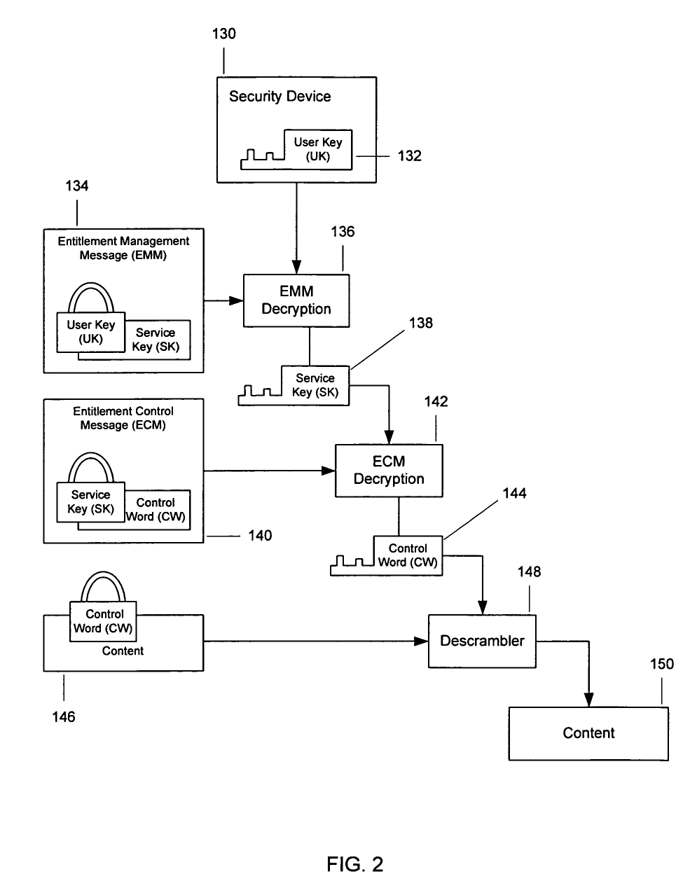

FIG. 3A illustrates an exemplary scenario for protecting the digital media. The figure shows various pertinent messages including a service key (SK), a control word (CW), and scrambled digital media content.

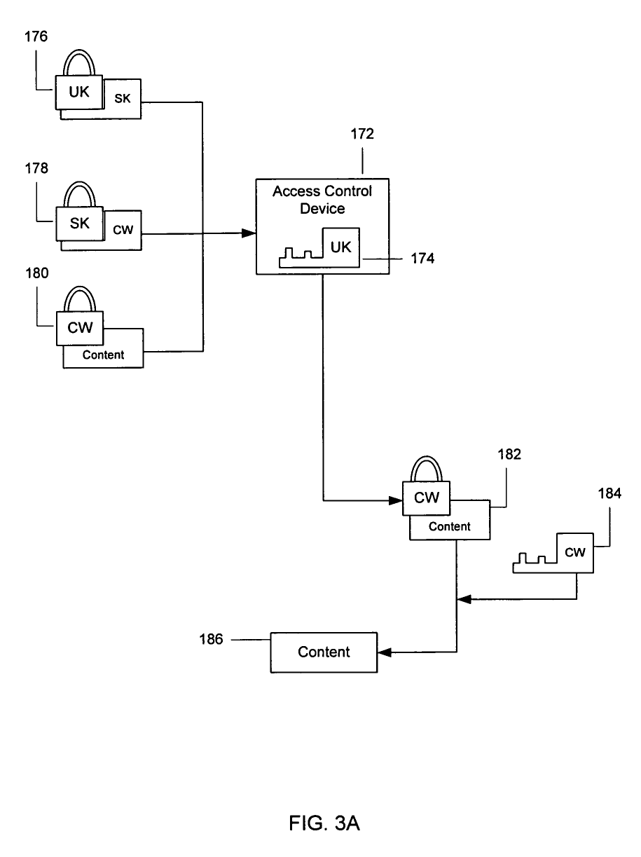

FIG. 3B illustrates another exemplary scenario in which the digital media is protected by a digital rights management (DRM) system.

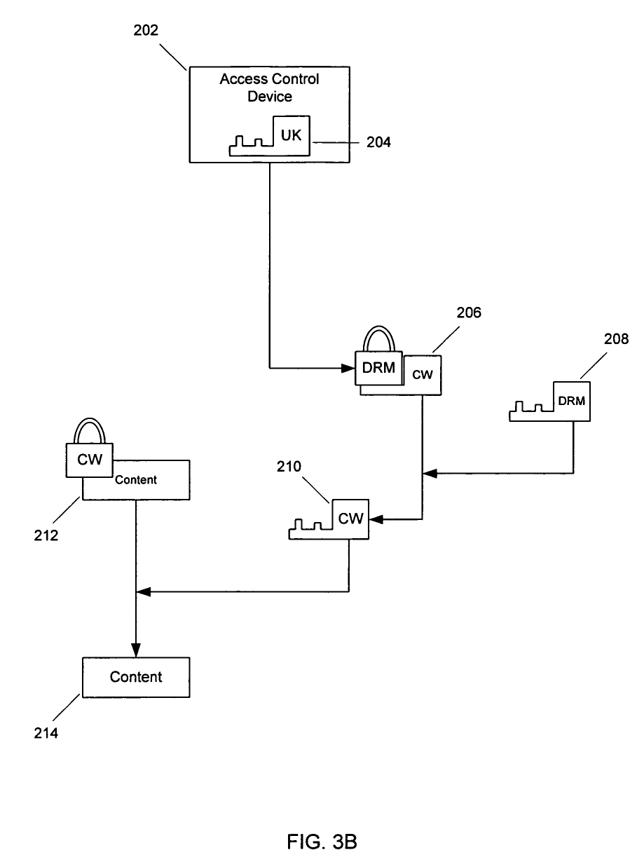

FIG. 4A illustrates an exemplary context where multiple DRM domains exist to protect the same digital media. The figure shows three DRM systems grouped into two DRM domains.

FIG. 4B illustrates an exemplary context where more than two CA and/or DRM systems are employed to protect digital rights. The figure includes a CA server and three DRM systems.

FIG. 4C shows a bridge between two DRM systems, “A” and “B”. The digital media content initially encrypted with a key, “CW A”, is encrypted with a different key, “CW B”, after the bridge.

FIG. 5A shows a prior art known as transcrambling, which transforms the input content scrambled with one key into the content scrambled a different key. The transformation occurs entirely within a hardware schematically denoted as a rectangular box in the figure.

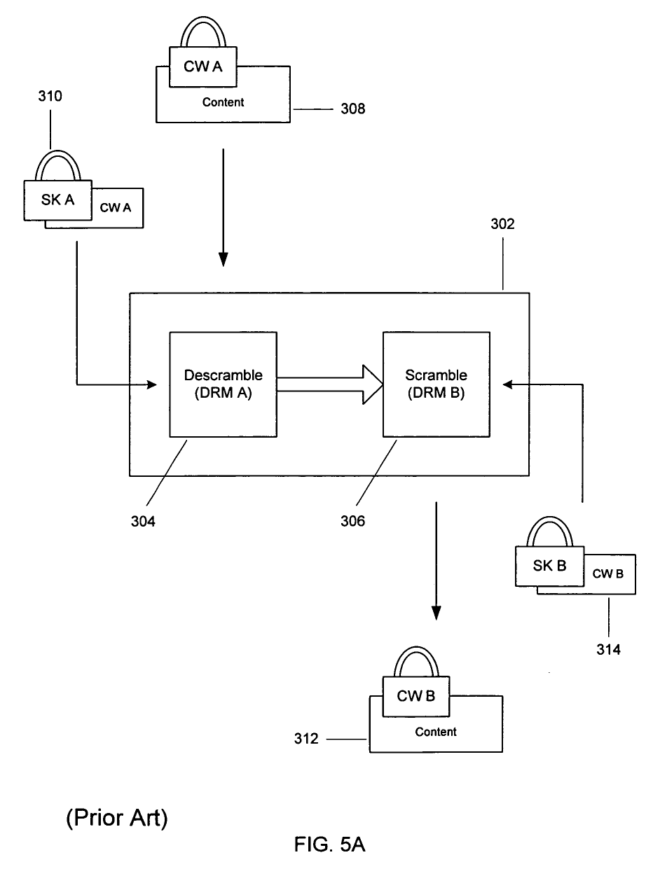

FIG. 5B shows a prior art known as superscrambling. The digital media content is doubly scrambled with two control words from two DRM systems. The doubly scrambled message also includes an encrypted control word.

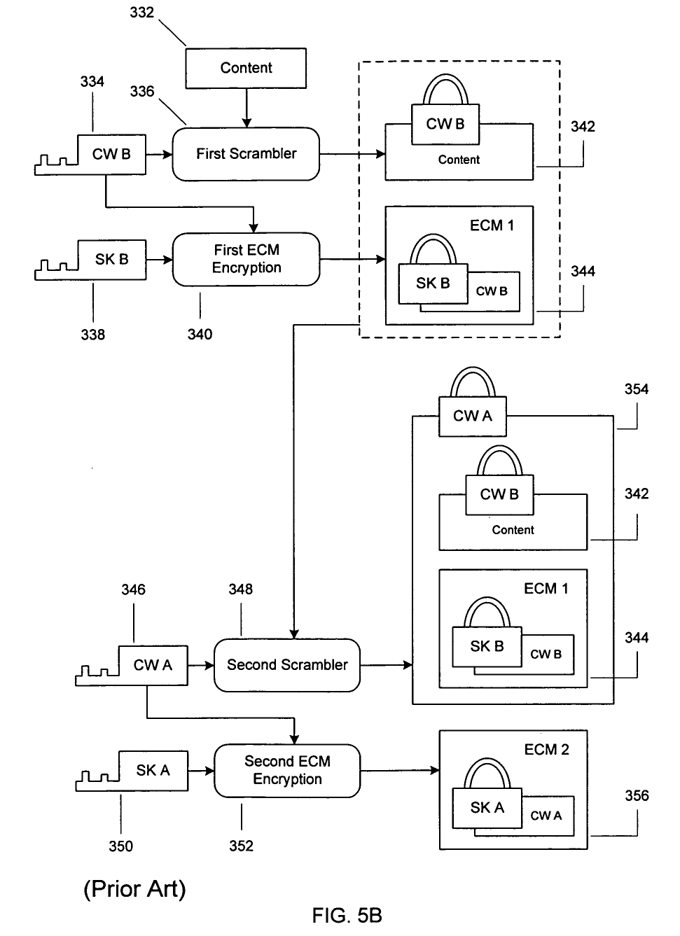

FIG. 5C shows a prior art known as simulcrypt. The figure shows two entitlement control messages (ECM). The control word, “CW A”, necessary to decrypt the scrambled digital media content can be obtained from either “ECM 1” or “ECM 2”.

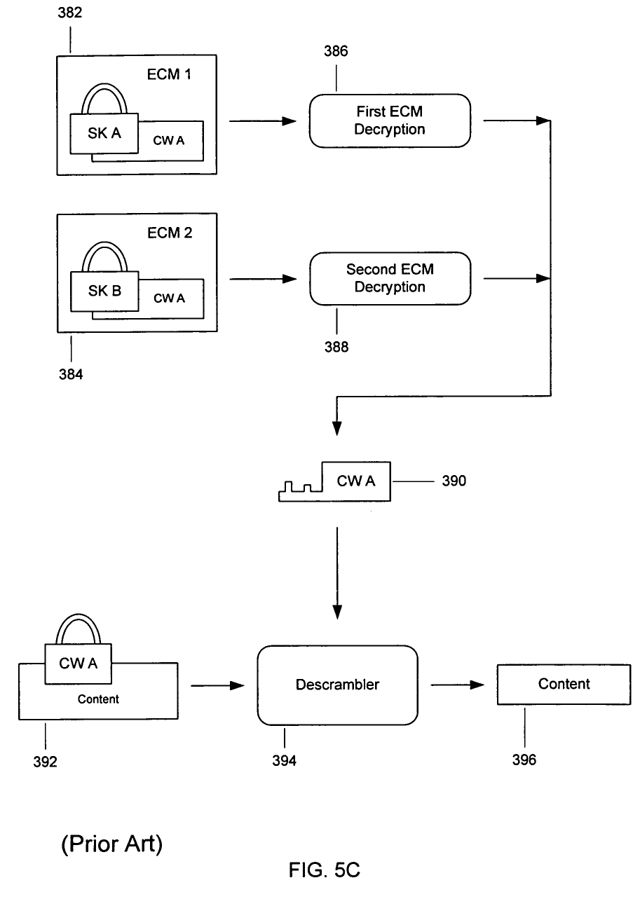

FIG. 5D shows a prior art method of bridging, known as a key rotation, which is based on the assumption that two DRM systems use the same content scrambling algorithm (common scrambling).

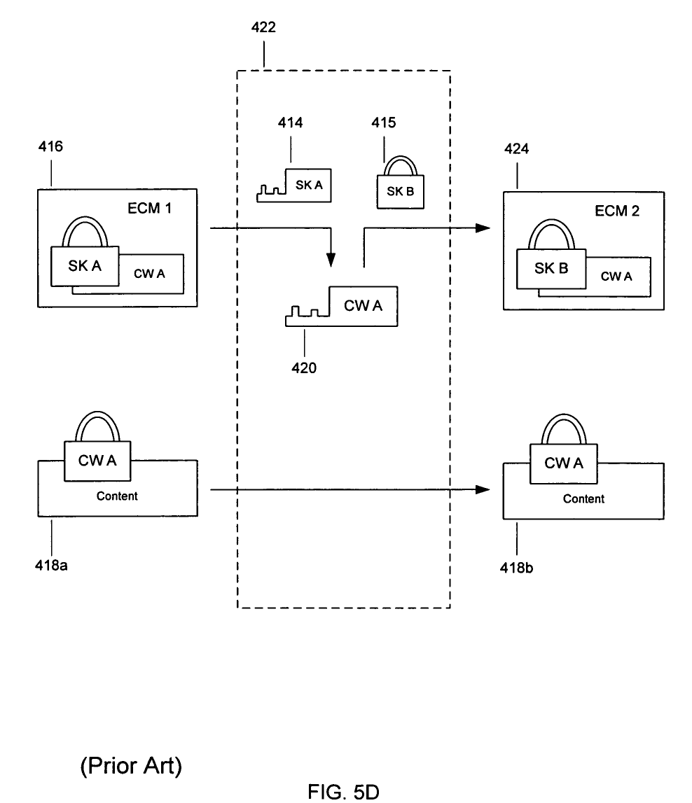

FIG. 6 shows an exemplary context where various embodiments of the present invention can be practiced.

FIG. 7 illustrates a typical “architecture” of a data processing system which may be used in relation with various embodiments of the present invention. For example, the exemplary system shown in the figure may represent a bridge or a DRM server.

FIG. 8A is a schematic representation of two exemplary digital rights management (DRM) systems. The figure also shows the pertinent encryption and decryption keys associated with each DRM system. The digital media content is protected by either or both DRM systems in this example.

FIG. 8B-FIG. 8D illustrate exemplary contexts where two DRM/CA systems are used to protect digital rights associated with digital media. The bridge shown in the middle of each figure divides the system into two regions. On the left-hand side, the media is protected by a CA system, whereas on the right-hand side, the media is under the protection of a different DRM system. In a typical application, the bridge is a DRM server relative to the DRM client a CA client relative to the CA server.

FIG. 9A shows an exemplary process in certain embodiments of the present invention. In particular, the figure illustrates an encryption or scrambling process according to an embodiment. As shown in the figure, the content is doubly scrambled (or, overscrambled) with two control words, “CW A” and “CW B”.

FIG. 9B shows a schematic representation of a DTCP (Digital Transmission Content Protection) data packet when used over IP according to an embodiment of the present invention. The DTCP packet encodes scrambled digital media content and other pertinent security keys.

FIG. 9C shows a list of encrypted messages and encryption/decryption keys in certain embodiments of the present invention. In particular, the content has been overscrambled as illustrated in FIG. 9A.

FIG. 9D illustrates an exemplary process for changing service keys, which is referred to as a key rotation, according to an embodiment of the present invention. In this example, the two service keys, “SK A” and “SK B”, are associated with two different DRM systems.

FIG. 9E illustrates an exemplary process for bridging between two digital rights management systems according to an embodiment of the present invention. This exemplary process includes a key rotation operation shown in FIG. 9D.

FIG. 9F illustrates an exemplary bridge connecting two digital rights management systems according to an embodiment of the present invention.

FIG. 9G shows an exemplary process at a bridge according to an embodiment of the present invention. The exemplary process is illustrated in the context of two DRM systems, denoted as “A” (e.g., “outer” or “global”) and “B” (e.g., “inner” or “local”).

FIG. 9H shows an exemplary decryption/descrambling process according to an embodiment of the present invention. The bridge between two DRM systems “A” and “B”, e.g., as illustrated in FIG. 9G, is shown between two broken lines.

FIG. 10 illustrates an exemplary process according to certain embodiments of the present invention as a flow chart. The process shown in the flow chart comprises three operations which may be performed by three distinct entities.

FIG. 11A is a flow chart illustrating an encryption/scrambling process according to an embodiment of the present invention. In particular, it shows an overscrambling operation of digital media content.

FIG. 11B is a flow chart illustrating a key rotation process according to an embodiment of the present invention.

FIG. 11C is a flow chart illustrating an exemplary process for bridging according to at least one embodiment of the present invention.

FIG. 11D is a flow chart illustrating a decryption/descrambling process according to an embodiment of the present invention.

FIG. 11E is a flow chart illustrating an exemplary decryption/descrambling process at a bridge/client according to certain embodiments of the present invention.

FIG. 12A illustrates an exemplary UDP data packet according to some embodiments of the present invention. As shown in the figure, the exemplary data packet includes scrambled digital media content and encoded security keys. UDP refers to a User Datagram Protocol (RFC 768), but other protocols may be used.

FIG. 12B illustrates an exemplary process at a bridge according to a certain embodiment of the present invention. The input UDP data packet with overscrambled digital media content is processed at the bridge to generate a singly scrambled content. The figure also shows a key rotation operation.

FIG. 12C illustrates an exemplary process, e.g., at a client, for parsing a portion of a UDP data packet and for descrambling the digital media content according to an embodiment of the present invention.

### DETAILED DESCRIPTION

The present invention will now be described more fully hereinafter with reference to the accompanying drawings, in which various exemplary embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Likewise, for purposes of explanation, numerous specific details are set forth in the following description in order to provide a thorough understanding of the present invention. It will be evident, however, to one skilled in the art that the present invention may be practiced without these specific details. In other instances, well-known structures and devices are shown in block diagram form in order to avoid unnecessarily obscuring the present invention.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiment.

The present invention provides systems, methods, and apparatuses for conditional access and protection of digital media content. Embodiments of the present invention provide methods for managing digital rights under the protection of one or more conditional access (CA) and/or digital rights management (DRM) systems. According to some embodiments, systems and methods are provided for bridging multiple DRM systems in the digital media distribution and storage systems. Generally speaking, the content is at first protected by different encryption algorithms from the multiple (e.g., two) DRM systems, and the decryption keys (e.g., first and second control words for the two different DRM systems) are protected by only one of the encryption algorithms (e.g., the first control word of the first DRM system). At a bridge or boundary between the two DRM systems, one layer of encryption from one of the DRM systems (e.g., the first DRM system) is removed (e.g. a first control word for the first DRM system is used to decrypt the twice encrypted content) to produce the content encrypted according to the second DRM system, and at the boundary (or potentially elsewhere) the first DRM system's encryption of the control word (“second control word”) of the second DRM system is removed by using a key of the first DRM system to obtain the second control word, which is then encrypted using a key of the second DRM system. At this point, the encrypted content (encrypted under the second DRM system) and the encrypted second control word (also encrypted under the second DRM system) may be used after having been extracted from the first DRM system.

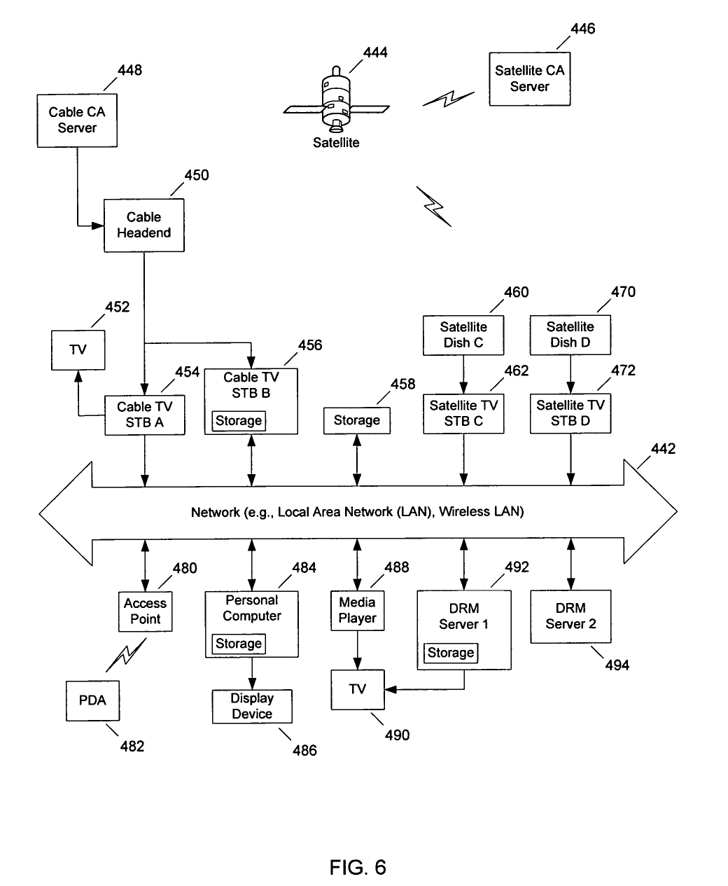

With reference now to figures, FIG. 6 illustrates an exemplary context where certain embodiments of the present invention can be practiced. More specifically, the drawing illustrates a networked system with two security system sources, 444 and 450, with their own conditional access servers, 446 and 448, respectively, and two DRM systems, 492 and 494. The figure also includes various clients, 454, 458, 462, 472, 484, and 488. In one embodiment of the present invention, these various components are connected to a network 442, such as a local area network (LAN) or a wireless LAN. The network 442 may be partially a wired Ethernet in a home of a service subscriber with one or more wireless access points for mobile devices such as a personal digital assistant (PDA), a palm computer, a notebook computer, or a cellular phone (e.g., connected to the network through a WiFi or Bluetooth connection). For example, in FIG. 6, the PDA 482 connects to the access point 480 through the wireless connection and further to other components through the network 442. The network may also be a network for an organization or a commercial establishment (e.g., a hotel or a motel chain), such as an intranet or a virtual private network.

In FIG. 6, a digital rights management (DRM) server 494 is used with the cable TV service. The cable conditional access (CA) server 448 couples with the cable headend 450 to provide the CA protected media content through the cable television transmission system to the cable TV bridges (e.g., 454 and 456) which may include cable TV tuners. The cable TV set-top boxes (STB) receive the data packages and de-multiplex the entitlement management messages (EMM) and entitlement control messages (ECM) and the scrambled media content. Under the control and protection of the DRM server 494, the media content can be secured on a storage (e.g., 456, 458, 484) for access by various devices which can play back the media content, such as the personal computer 484, the media player 488, or the PDA 482. The personal computer 484 typically displays the video content on the display device 486, such as a cathode ray tube (CRT) monitor, a liquid crystal display (LCD) panel, or a plasma display panel. The media player 488 may present the media content on a television set 490. A media player may also be integrated with a television set to form a network-ready digital television set.

In one embodiment, the DRM server 494 provides services to descramble/decrypt the cable TV broadcast. The decrypted/descrambled information is further protected by the DRM system so that the media content from the broadcast of the cable TV system can be used in an authorized way. When authorized, the content can be recorded and played back at any time on any device convenient to the user in accordance with the rights of the subscriber. For example, with a subscription to only one simultaneous use, a user may choose to use cable TV set-top box 454 to receive the broadcast and view the program on the TV 452, or use cable TV set-top box 456 to record the program on the associated storage for playing back at a different time, for example, using PDA 482, personal computer 484, or media player 488. In some embodiments, the media content and/or associated keys are protected by encrypting the data with encryption keys associated with the DRM system 494.

In FIG. 6, another DRM system 492 is used in association with both the satellite TV set-top box C 462 and the satellite TV set-top box D 472. The DRM server 492 may store the protected media content on its storage or on other storage devices on the network, such as the storage on the personal computer 484 or the storage 458. Typically, a satellite 444 broadcasts the protected media content to a geographical area. Separate satellite dishes (e.g., 460 and 470) are used for different satellite set-top boxes (e.g., 462 and 472, respectively). Typically, to access two different channels simultaneously, two set-top boxes are used. Satellite set-top boxes are independent from each other. The satellite broadcasts to the two set-top boxes as if the set-top boxes were for two different subscribers. In certain embodiments of the present invention, one DRM server (e.g., 492) is used to manage digital rights associated with multiple set-top boxes (e.g., 462 and 472).

In an embodiment, one or more DRM servers are used to protect digital media which have been originally delivered by one or more servers, such as CA servers, which makes desirable to have bridges between the DRM systems to simplify content management, while enforcing digital rights management within both DRM systems. In one embodiment of the present invention, multiple DRM servers are physically in one data processing device with different software and smart cards for the processing of the messages of different CA systems. Further, a DRM server may be integrated with a bridge, a storage device, a renderer (e.g., PDA 482, personal computer 484, media player 488), or combination of them. For example, the DRM system 492, which may be used in conjunction with a satellite TV CA server 446, may include a storage for recording media content, a interface between a satellite dish and a renderer for decoding the media content into standard video signals (for a television set and/or for a computer monitor).

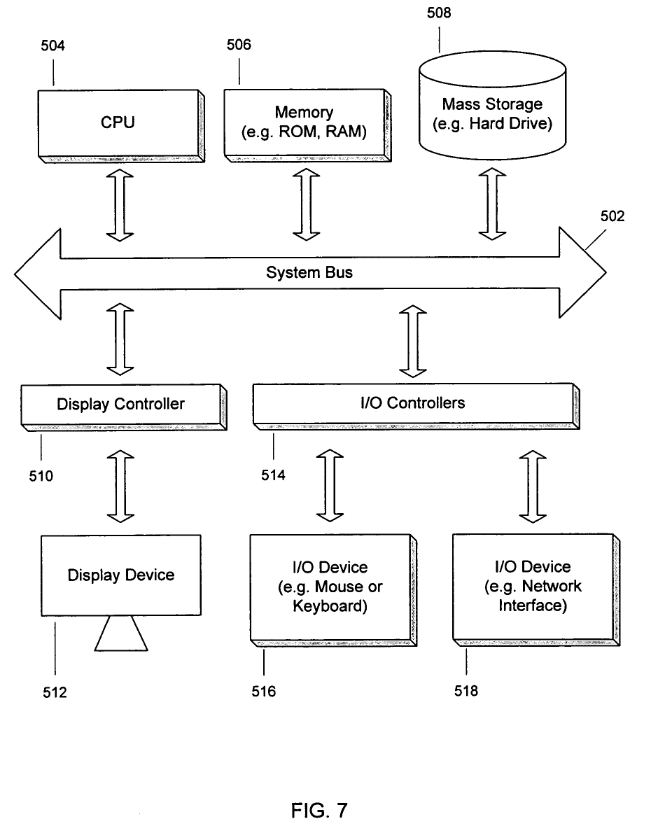

FIG. 7 illustrates a typical “architecture” of a data processing system, which may be used with various embodiments of the present invention. For example, the system shown in the figure may represent an exemplary bridge implementation according to an embodiment. Or, it may represent an exemplary DRM server. As will be appreciated by one of skill in the art, the present invention may be embodied as a method, data processing system or program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code means embodied in the medium. Any suitable storage medium may be utilized including hard disks, CD-ROMs, DVD-ROMs, optical storage devices, or magnetic storage devices. Thus the scope of the invention should be determined by the appended claims and their legal equivalents, and not by the examples given. Note that while FIG. 7 illustrates various components of a data processing system, it is not intended to represent any particular architecture or manner of interconnecting the components as such details are not germane to the present invention. It will also be appreciated that network computers and other data processing systems (such as cellular telephones, personal digital assistants, media players, etc.) which have fewer components or perhaps more components may also be used with the present invention.

As shown in FIG. 7, the computer system, which is a form of a data processing system, includes a bus 502 which is coupled to a microprocessor(s) 504 and a memory 506 such as a ROM (read only memory) and a volatile RAM and a non-volatile storage device(s) 508. The storage device may be used to store digital media content in certain embodiments. The system bus 502 interconnects these various components together and also interconnects these components 504, 506, and 508 to a display controller(s) 510 and display devices 512 and to peripheral devices such as input/output (I/O) devices 516 and 518 which may be mice, keyboards, modems, network interfaces, printers and other devices which are well known in the art. Typically, the I/O devices 516 and 518 are coupled to the system through one or more I/O controllers 514. The volatile RAM (random access memory) 506 is typically implemented as dynamic RAM (DRAM) which requires power continually in order to refresh or maintain the data in the memory. The mass storage 508 is typically a magnetic hard drive or a magnetic optical drive or an optical drive or a DVD ROM or other types of memory system which maintain data (e.g. large amounts of data) even after power is removed from the system. Typically, the mass storage 508 will also be a random access memory although this is not required. While FIG. 7 shows that the mass storage 508 is a local device coupled directly to the rest of the components in the data processing system, it will be appreciated that the present invention may utilize a non-volatile memory which is remote from the system, such as a network storage device which is coupled to the data processing system through a network interface 518 such as a modem or Ethernet interface. The bus 502 may include one or more buses connected to each other through various bridges, controllers and/or adapters as is well known in the art. In one embodiment, the I/O controller 514 includes a USB (universal serial bus) adapter for controlling USB peripherals and an IEEE 1394 (i.e., “firewire”) controller for IEEE 1394 compliant peripherals. The display controllers 510 may include additional processors such as GPUs (graphical processing units) and they may control one or more display devices 512. The display controller 510 may have its own on-board memory.

It will be apparent from this description that aspects of the present invention may be embodied, at least in part, in software. That is, the techniques may be carried out in a computer system or other data processing system in response to its processor, such as a microprocessor, executing sequences of instructions contained in a memory, such as ROM or RAM 506, mass storage, 508 or a remote storage device. In various embodiments, hardwired circuitry may be used in combination with software instructions to implement the present invention. Thus, the techniques are not limited to any specific combination of hardware circuitry and software or to any particular source for the instructions executed by the data processing system. In addition, throughout this disclosure, various functions and operations may be described as being performed by or caused by software codes to simplify the description. However, those skilled in the art will recognize what is meant by such expressions is that the functions result from execution of the code by a processor, such as the CPU unit 504.

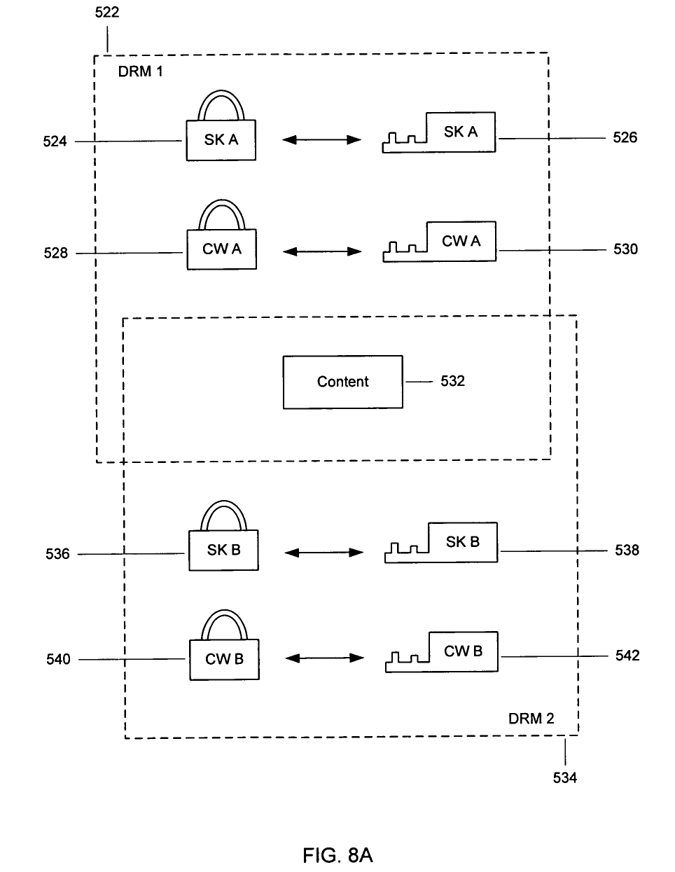

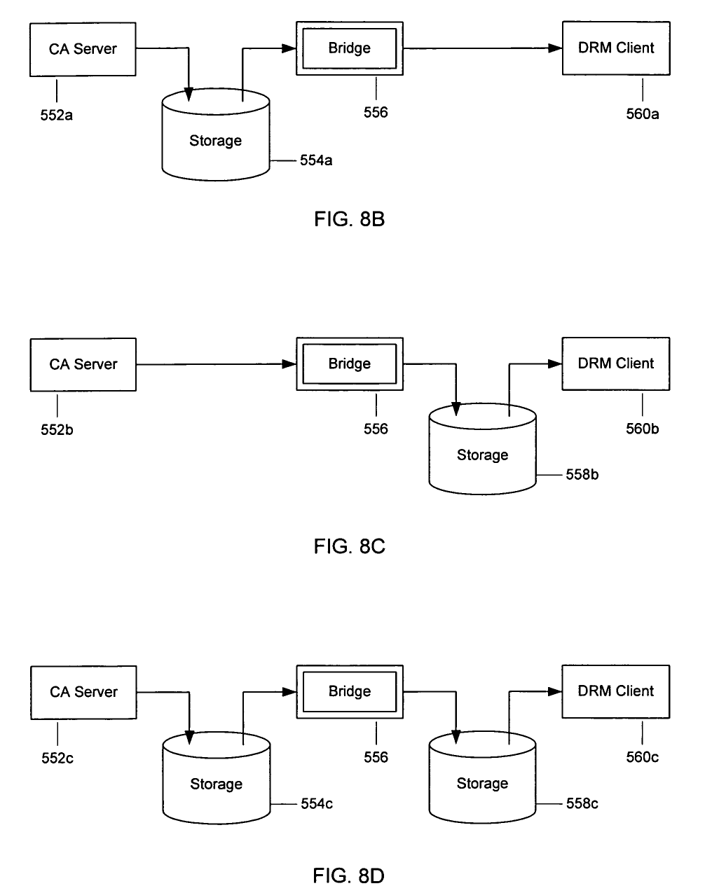

With reference now to FIGS. 8-12, various embodiments of the present invention are described in detail. FIGS. 8A-8D illustrate exemplary contexts in which some of the embodiments of the present invention can be practiced. In FIG. 8A, a schematic representation of two exemplary digital rights management (DRM) systems, 522 and 534, are depicted. Each DRM system is symbolically represented by its encryption and decryption keys. More specifically, the DRM system 522 comprises encryption keys 524 and 528 and their corresponding decryption keys 526 and 530, respectively, and the DRM system 534 comprises encryption keys 536 and 540 and their corresponding decryption keys 538 and 542, respectively. In the case of cable TV broadcasting, the first pair of encryption and decryption keys (e.g., 524 and 526) represents service keys (SK), and the second pair (e.g., 528 and 530) represents control words (CW). Control words are used to scramble and/or descramble digital media content. In some embodiments, symmetric key cryptography may be used for certain tasks or functions. In such a case, one or more pairs of encryption and decryption keys may be identical or otherwise equivalent (in computational sense) to each other. For example, if symmetric key cryptography is used in DRM system 522 for scrambling digital media content, then the keys 528 and 530 are essentially identical. In some cases, encryption key 528 may be derived from decryption key 530, but not vice versa. In some embodiments, content encryption (e.g., scrambling media content with control words) is done using symmetric key cryptography and key encryption (e.g., encrypting control words with service keys) is done using asymmetric key cryptography. In general, encryption/decryption schemes based on symmetric key cryptography are computationally less expensive than those using asymmetric key cryptography.

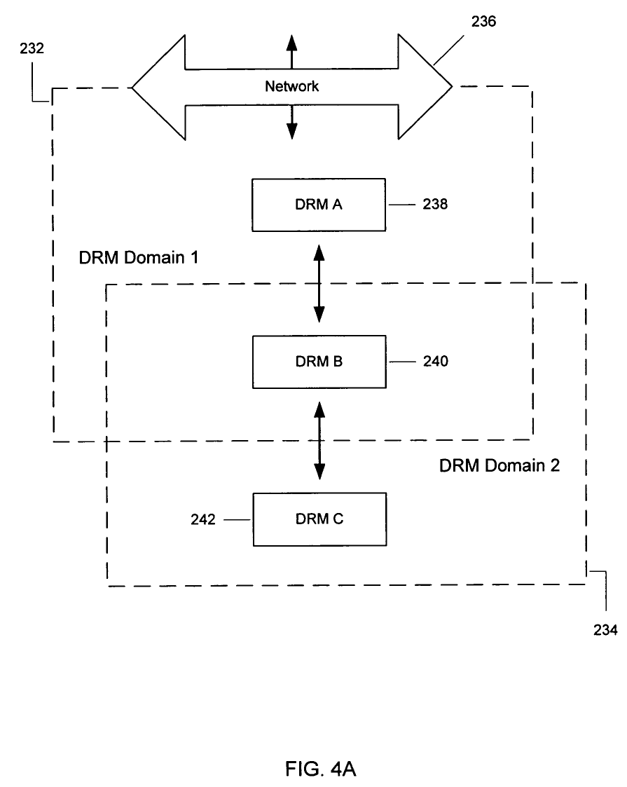

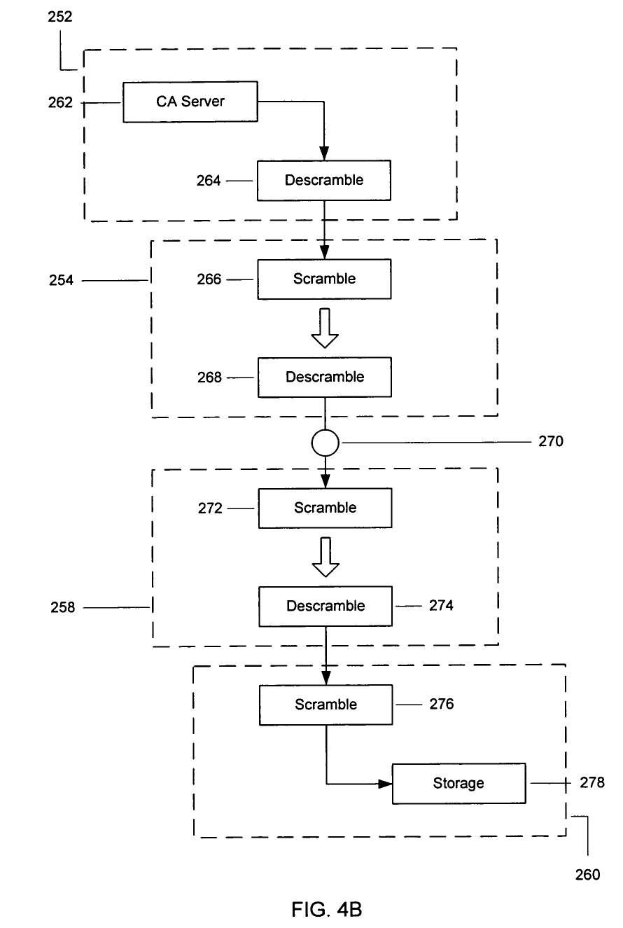

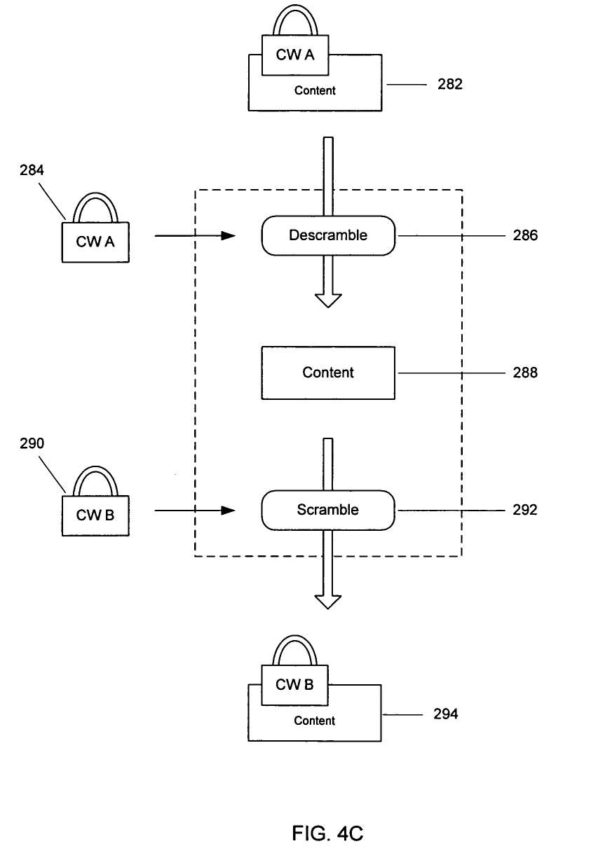

FIG. 8A also shows digital media content 532 which may be under the protection of the first DRM system 522 or the second DRM system 534, or both. These two DRM systems may be employed for protection of the digital media either at the same time or alternately at different times or at different stages of delivery and processing. For example, the digital media owners such as movie studios and media distribution services such as cable network companies might utilize different and separate DRM systems (e.g., 522 and 534) for the same digital media, or for different parts of the same media. This has been illustrated, for example, with respect to FIGS. 4A, and 4B. In the example shown in FIG. 8A, the digital media 532 delivered, for example, from a conditional access server (not shown in the figure) may first be protected by the first DRM system 522, which may be managed by the CA server, for example, associated with a cable company. In order to play the delivered content, the user may need to get proper access permission from both the CA system and the DRM system 522. Suppose now that the digital media content has been played and stored for later viewing. The stored content may then be placed under the protection of the second DRM system 534, which may be managed, for example, by a movie studio who has the copyright on part or all of the stored digital media or by a certain content management device or software. In certain embodiments, the stored content may still be protected by the first DRM system 522 together with the second system 534. In certain embodiments, at some point during the media delivery, processing, playing, and storage processes, the protection by the first DRM system 522 may be removed and the stored digital media 532 may be protected only by the second DRM system 534. In this type of application, the first DRM system 522 will be considered more “global” (e.g., closer to the distributor of the digital media) whereas the second DRM system 534 will be considered more “local” (e.g., closer to the consumer of the digital media).

This is further illustrated in FIGS. 8B-8D with regards to different examples. The drawings illustrate exemplary contexts where two DRM/CA systems are used to protect digital rights associated with digital media as in the example of FIG. 8A. The bridge shown in the middle of each figure divides the system into two regions. On the left-hand side, the media is protected by a CA/DRM system, whereas on the right-hand side, the media is under the protection of a different DRM system. A bridge will typically include a CA client (or DRM client for a first DRM system) and a DRM server (for a second DRM system); the CA client is a client relative to the CA server, and the DRM server is a server relative to the DRM client. The first DRM system (i.e., the left-hand side CA server in the figures) and the second DRM system may be associated with control words 528/530 and 540/542 of FIG. 8A, respectively. It should be noted that more than one (pair of) control word (and/or more than one service key) might be associated with each DRM system even though it is not explicitly indicated in these figures. As stated earlier, in some systems such as those used in the cable TV broadcasting, the typical lifetime of a control word is of the order of 0.1 second or 1 second. Referring back to FIGS. 8B-8D, a DRM bridge 556 is shown in the middle of each figure. On the left hand side of the bridge, the digital media is delivered from a CA server, 552. On the right hand side, it is consumed by a client (e.g., associated with a DRM client, 560). FIG. 8B depicts a scenario where the digital media content is delivered by CA server 552a and is further protected the same CA server (or, “global” DRM). The media is stored on a storage 554a, such as a set-top box, on the left hand side of the bridge. In this particular scenario, the second, or “local”, DRM system (e.g., indicated by DRM client 560a in the figure) relies on the CA server 552a to enforce the digital rights. As such, the CA server should always be available. In FIG. 8C, on the other hand, the media content delivered from a CA server 552b is stored on a storage, such as a personal computer, on the right-hand side of the bridge 556. It should be noted that the bridge typically includes a DRM server and a CA client. In these examples, the bridge 556 plays the role of “local” DRM server protecting digital media on the right hand side (e.g., consumer side). In this scenario, the local DRM system (e.g., the bridge 556) enforces the digital rights protection for the media content stored in the storage 558b. FIG. 8D illustrates yet another example, in which the digital media content is stored in more than one device. For example, storage 554c may be a personal computer or a DVR (digital video recorder), and storage 558c may be a mobile device. Then the bridge 556 may be a part of “sync” agent enforcing digital rights protection. In this example, the media content is first delivered by a CA server 552c, stored in 554c, and further protected by the same CA system (or by a different DRM system). When a user “copies” the media content to a different device/storage 558c under the protection of a different DRM system on the “local” side, the bridge 556 is involved. Then, the media can be played or otherwise consumed, in compliance with the proper rights, “locally” without the need to access the original (or, “global”) DRM or CA server (e.g., 552c).

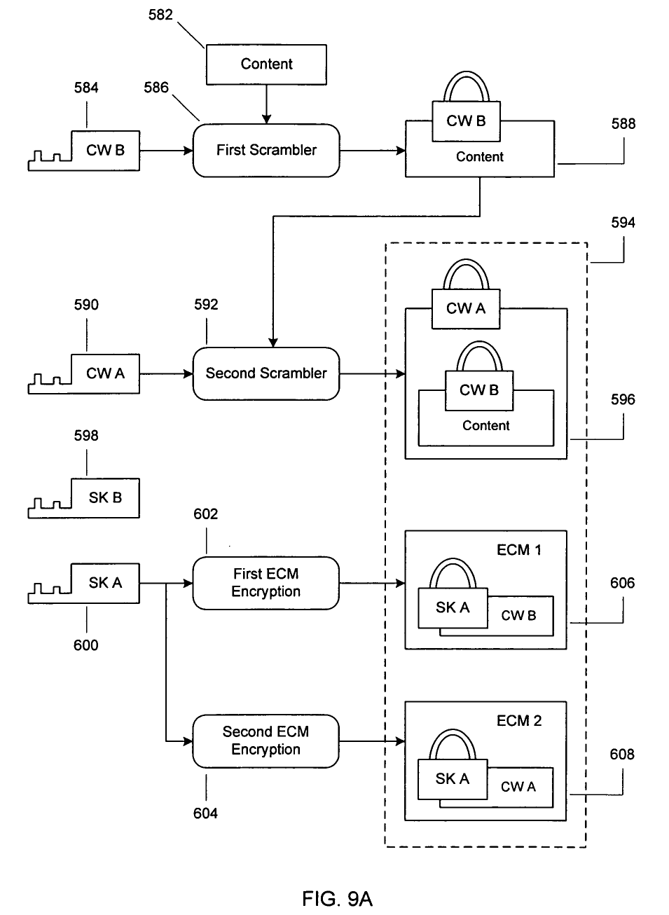

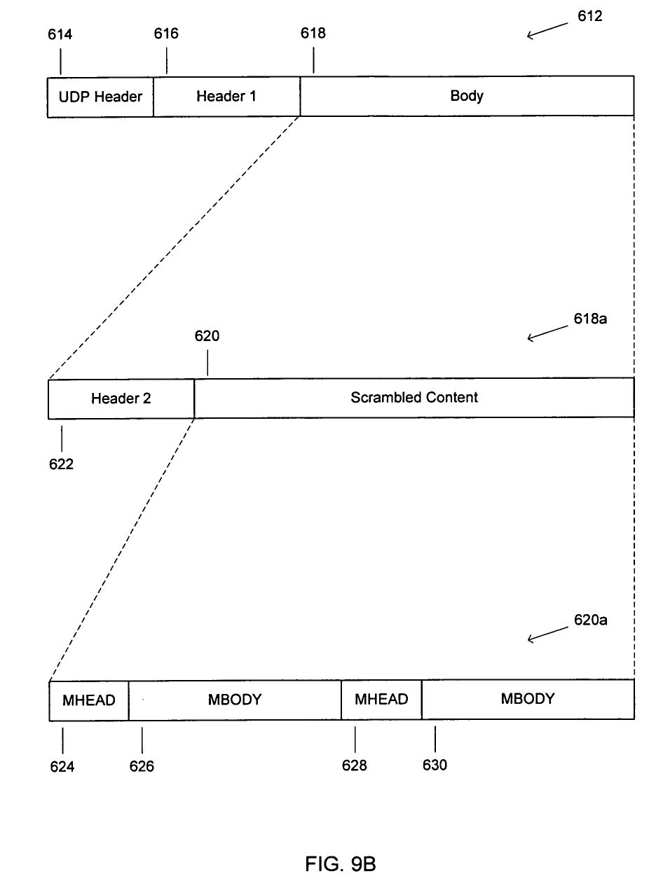

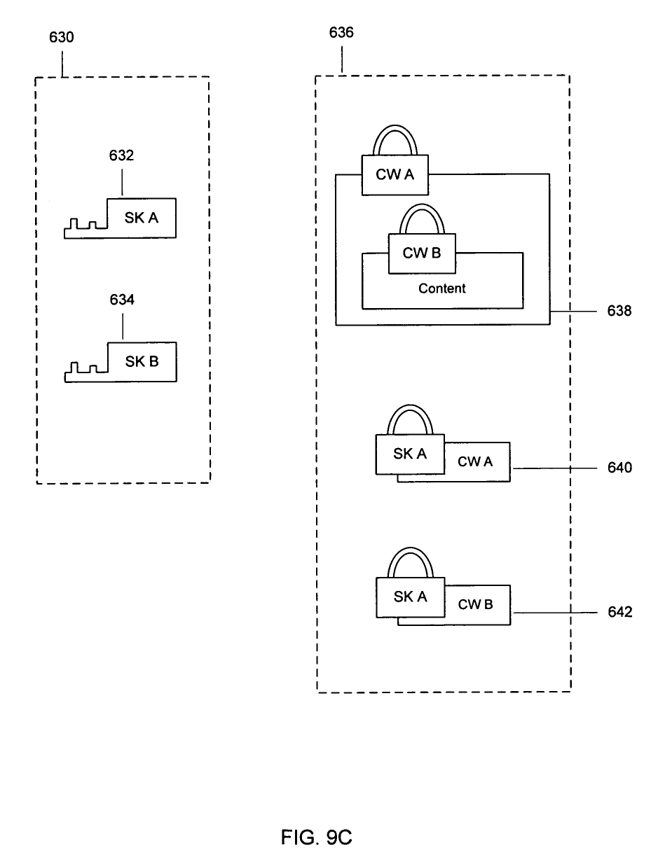

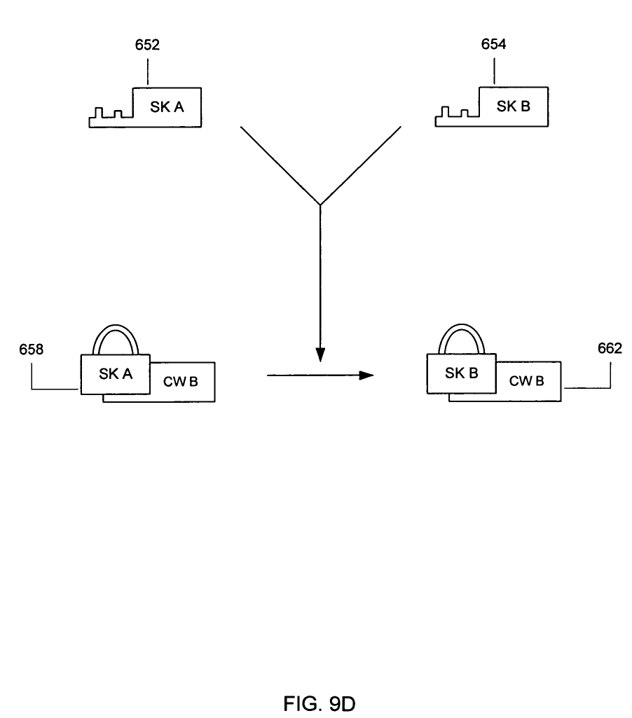

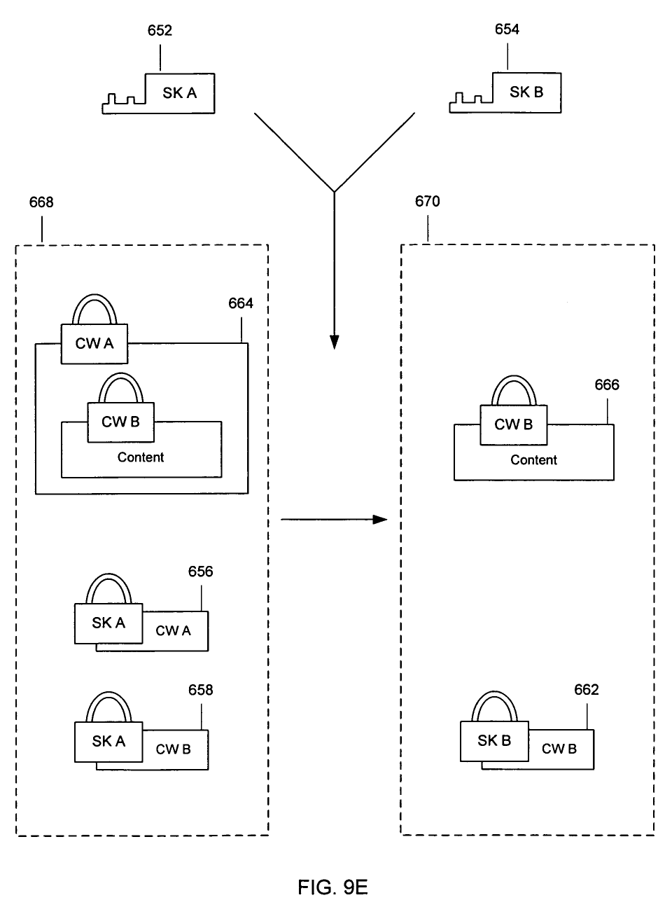

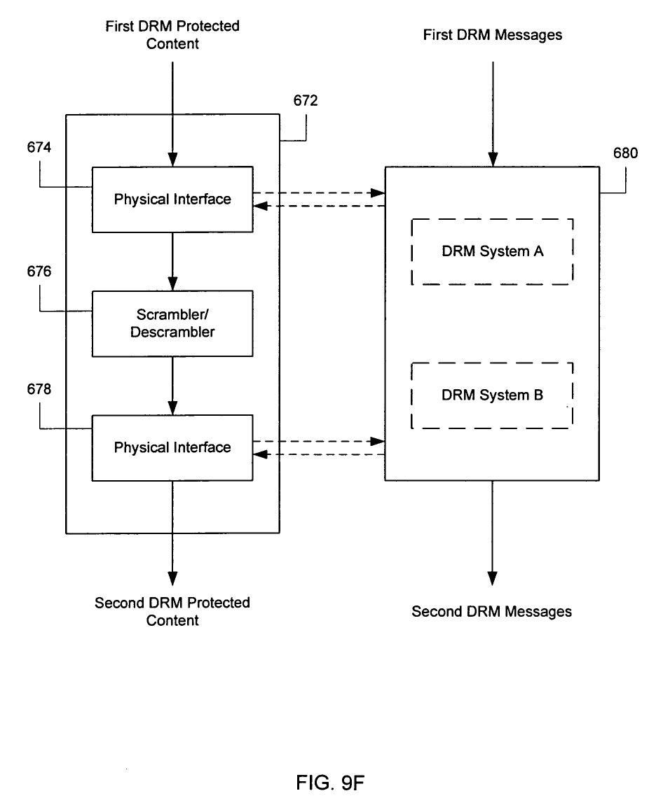

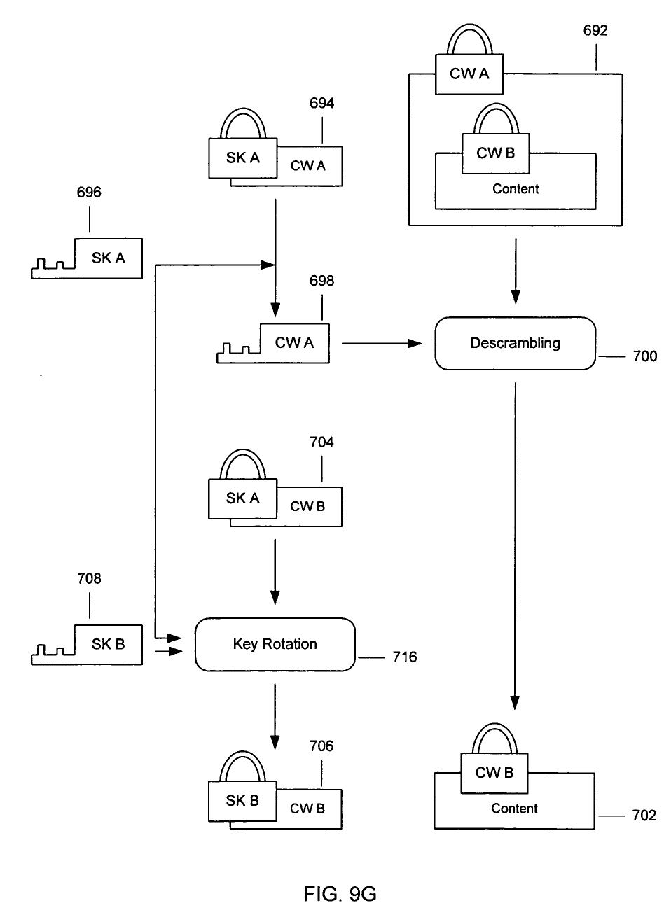

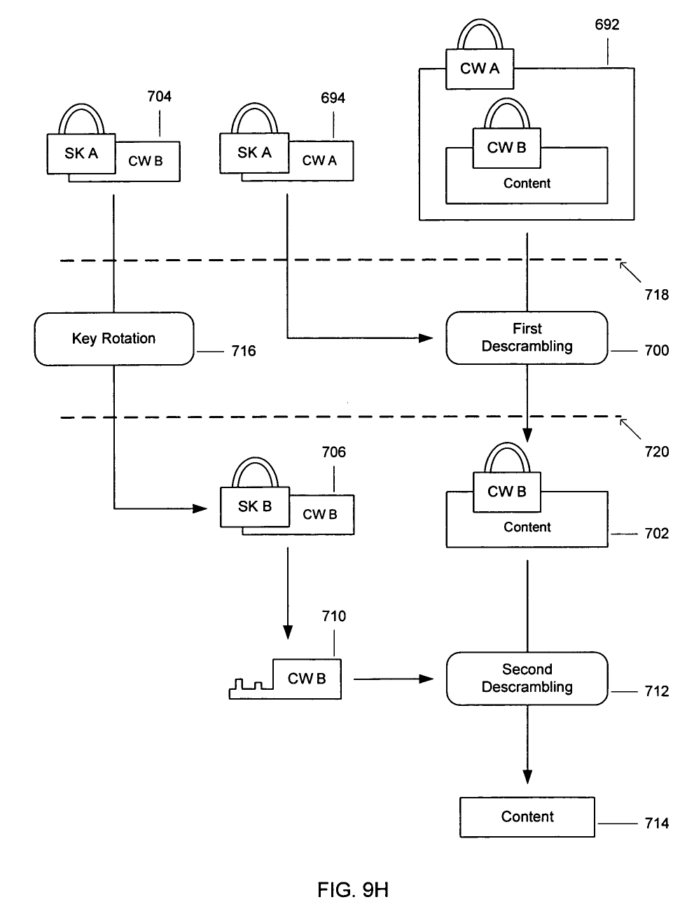

When the digital media is passed from one DRM system to another DRM system, the media (and its associated keys) may be descrambled/decrypted using the keys from one DRM system (e.g., 552) and rescrambled/encrypted using the keys from the next DRM system (e.g., 556 and 560). In the examples illustrated in FIG. 8B-8D, the media under the protection of the first DRM system and/or a CA server is descrambled and scrambled again for the next DRM system, for example, in the bridge 556. Whenever the digital media passes the DRM system boundaries (e.g., the bridge 556), the media (and/or any associated security keys) may be exposed in clear forms. This has been illustrated, for example, with reference to FIG. 4C. In general, this problem occurs when a digital media is protected by multiple digital rights management systems (and/or conditional access servers). During the lifetime of the digital media, the media may be protected by one or more of these DRM and/or CA systems at any given moment. As illustrated earlier, different DRM systems may be involved in different stages of media delivery and processing. Whenever the media crosses boundaries of different DRM systems, the system may become vulnerable and the media content may be exposed to unauthorized uses. In the following, with reference to FIGS. 9-12, various exemplary embodiments of the present invention are presented, some of which address this security issues at or around the bridge points. The following examples will be explained in the context of two DRM systems. As will be evident, however, to those skilled in the art, embodiments of the present invention may be practiced with more than two systems for digital rights protection.

Referring now to FIGS. 9A-9H, various aspects of certain embodiments of the present invention are illustrated. FIG. 9A illustrates an encryption or scrambling process according to an embodiment. This exemplary process pertains to encrypting digital media content 582 and two control words, 584 and 590, each of which may be associated with a different digital rights management (DRM) system. First, digital media content 582 is scrambled, at 586, with a control word 584 (“CW B”) associated with a target (or, “outer” or “local”) DRM system, and a scrambled media content 588 is created, which is illustrated as a “locked” content with a lock labeled “CW B” in the figure. Then, the scrambled content 588 is scrambled again, at 592, with another control word 590 (“CW A”), which creates doubly scrambled, or “overscrambled”, digital media content 596. It should be noted that, in certain embodiments, the content 582 might represent a segment of a “program” which lasts, for example, 0.1 second, during which the control words 584 and 590 are in effect. In certain other embodiments, the content 582 may correspond to a whole program such as a movie title. Next, control words are in turn encrypted with service keys associated with the DRM systems. In one embodiment, each control word (e.g., 584 and 590) is encrypted with its corresponding service key (e.g., 598 and 600, respectively). In the embodiment shown in FIG. 9A, both control words 584 and 590 are encrypted with the same service key, i.e., service key 600 managed by the DRM system associated with control word 590 in this example (“global” or “outer” DRM). As illustrated in the figure, control word 584 is encrypted, at 602, with service key 600 (“SK A”) and the first encrypted message (e.g., entitlement control message, or ECM) 606 is created. Control word 590 is then encrypted, at 604, again with the same service key 600 and the second encrypted message 608 is created. This set of encrypted messages, shown in the broken-line box 594 in the drawing, which comprises the overscrambled content 596 and the encrypted control words 606 and 608, is delivered to a bridge or a client, possibly with other messages which include, for example, entitlement (e.g., service keys 598 and 600) for the particular client(s) and/or for the delivered digital media. In some embodiments, the entitlement messages are delivered to the bridge in response to a client's request. In some cases, the encrypted control words are also delivered “on-demand” when an explicit request is made from the client, for example, at the time of storage or playback of the digital media.

In some embodiments of the present invention, a conditional access (CA) server delivers digital media through IP network using DTCP (Digital Transmission Content Protection) packets. DTCP is a standard for protecting digital rights during the transmission of digital media. The CA server creates DTCP packets with payload including digital media content and various keys, which may be encrypted or scrambled. This is illustrated in FIG. 9B. The figure shows a schematic representation of a DTCP data packet 612. The data packet encodes scrambled/overscrambled digital media content 618 according to an embodiment of the present invention. The packet 612 includes a UDP (User Datagram Protocol) header 614 in this example. The packet also includes a portion, or a header, 616 which is associated with a payload or a body 618 including the scrambled content 620. The payload 618a may contain another header 622. As in the example shown in FIG. 9A, the content 620 may have been doubly encrypted and the headers 616 and 622 may carry the information regarding the “outer” and “inner” layer scrambling, respectively (e.g., scrambling with the control words 590 and 584 of FIG. 9A). In some embodiments, the header 616 comprises an ECM (e.g., the encrypted control word 608 of FIG. 9A) and/or an EMM. Likewise, the header 622 may contain relevant ECMs and/or EMMs. According to an embodiment of the present invention, each block of the content 620 of FIG. 9B is scrambled with a block cipher such as AES (Advanced Encryption Standard) or DES (Data Encryption Standard) or 3DES (Triple DES). Other common encryption algorithms include M2 (multi 2) and M6 (multi 6), and DVB-CSA as mentioned earlier. Multiple blocks, or the whole content, may be encrypted according to AES and CBC (Cipher Block Chaining) or AES and ECB (Electronic Codebook). FIG. 9B also illustrates the scrambled content in further detail, as shown at the bottom of the drawing as 620a. The content may have been scrambled (not explicitly indicated in the figure) with another control word (e.g., 584 of FIG. 9A), and header 622 may include the associated ECM (e.g., 606 of FIG. 9A) in some embodiments, as stated earlier. The content is typically encoded with MPEG-2 formats. FIG. 9B shows multiple MPEG headers, 624 and 628, and bodies, 626 and 630. In certain embodiments, the inner layer is scrambled with a different encryption scheme, such as AES in conjunction with CTR (a block cipher mode of operation known as Counter) or 3DES +CBC, from that used for the outer layer.

In some embodiments of the present invention, different DRM systems may utilize different scrambling schemes. For example, the first scrambling 586 and the second scrambling 592 of FIG. 9A use different scrambling schemes in certain embodiments. Or, the scrambled content 620 (scrambling not explicitly shown) in FIG. 9B are encrypted or overscrambled by different scrambling schemes in certain embodiments of the present invention. In this description, a scrambling scheme refers to various features, as a whole, of an encryption method. For example, a scrambling scheme comprises an encryption algorithm (AES vs. 3DES, etc.) and a mode of operation in block cipher (CBC vs. CTR vs. ECB, etc.). In some cases, content formatting/encoding (e.g., MPEG transport stream, etc.) is also considered a part of a scrambling scheme. The “inner data packet” 620a shown in FIG. 9B, for example, uses a scrambling scheme comprising an MPEG encoding, as symbolically indicated in the figure by MPEG headers 624 and 628 and MPEG bodies 626 and 630.

Turning now to FIG. 9C, a list of pertinent messages is shown according to an embodiment of the present invention. The list 636 includes doubly scrambled digital media content 638 encrypted with two control words, an “outer” or “global” control word 640 encrypted with a service key 632, and an “inner” or “local” control word 642 encrypted with the same service key 632. This set of encrypted messages and relevant service keys 630 are utilized in certain embodiments for bridging different digital rights management (DRM) systems (e.g., between a “global” and “local” ones). The list 636 is an outcome of the overscrambling (e.g., as shown in FIG. 9A), and it is used as an input to the bridge in certain embodiments (e.g., as illustrated in FIGS. 9G and 9H). The bridge and/or client typically needs authorization from the relevant DRM servers, for example, as a form of service keys. FIG. 9C shows another service key 634 associated with an “inner” or “local” DRM system.

The present invention provides methods and apparatuses for bridging multiple digital rights management (DRM) systems in the digital media content distribution and storage systems. In particular, embodiments of the present invention provide various methods for switching encryption keys between two different DRM systems. At least one inventive method comprises encrypting a control word associated with one DRM system with a service key associated with another DRM system. In certain embodiments, the service key used to encrypt the control word can be switched with a different service key which may be associated a different DRM system. This process is called a “key rotation” in this disclosure. According to an embodiment, a method is employed to rotate keys at a bridge between a first digital rights management system and a second digital rights management system, where the first and second DRM systems have a first and second service keys, respectively. An exemplary process is illustrated in FIG. 9D according to an embodiment of the present invention. The method comprises receiving an encrypted message 658 comprising a “local” control word (“CW B”) encrypted with the “global” service key 652 from the first DRM system, decrypting the encrypted message using the first service key 652, and generating another encrypted message 662 comprising the local control word encrypted with a local service key 654. In some embodiments, the service keys, 652 and 654, are delivered to the bridge prior to, or concurrently with, the delivery of digital media content and/or the encrypted messages.

An exemplary bridging process is further illustrated in FIG. 9E according to certain embodiments of the present invention. The figure shows the lists of input messages 668 and output messages 670 at the bridge. The exemplary process comprises receiving an overscrambled digital media content 664, which is scrambled with both a first control word and a second control word, receiving a first encrypted message 656 comprising the first control word encrypted with the first service key 652 from the first DRM system, and receiving a second encrypted message 658 comprising the second control word encrypted with the first service key 652 from the first DRM system. The method further comprises decrypting the second encrypted message using the first service key 652 and generating another encrypted message 662 comprising the second control word encrypted with the second service key 654 (e.g., key rotation). In some embodiments, the first service key, 652 is delivered to the bridge prior to, or concurrently with, the delivery of digital media content and/or the encrypted messages. The second service key, 654 may be generated or received by the bridge. In certain embodiments of the present invention, the first encrypted message 656 is preserved during the key rotation and simply transmitted to the next layer (e.g., to the client). In certain other embodiments, the first encrypted message 656 is discarded at the bridge. In such a case, the output messages, including the scrambled content, may be under the protection of only one digital rights management system (i.e., the second DRM system denoted as “B”). The “outer layer” scrambling of the overscambled digital media content 664 is typically removed at the bridge, and the output 670 from the bridge usually contains a singly scrambled content 666 (e.g., only with the “local” control word) as well as the key-rotated ECM 662. According to an embodiment of the present invention, these encrypted messages and the scrambled content are delivered at the same time, e.g., during the time of initial distribution for playback. Or, in other embodiments, the scrambled content is delivered first and the necessary keys are distributed later, for example, in response to a request from the client.

FIG. 9F illustrates an exemplary bridge 672, according to an embodiment of the present invention, in relation with two digital rights management systems as indicated by a rectangular box 680 in the figure. In this example, the DRM “server” 680 processes security messages, such as ECMs and EMMs, for example, from neighboring DRM and/or CA systems. The exemplary bridge 672 in the figure includes a number of components, such as physical interfaces, 674 and 678, and scrambling/descrambling unit 676. For example, the physical interface 674 may be a tuner which converts the signals representing the first DRM protected content into a data format, the scrambling/descrambling unit 676 may convert the protected content from one protected (e.g., encrypted) format to another protected (e.g., encrypted) format, and the physical interface 678 may be a data network communication interface for transmitting the protected content to a client in the next DRM system. In at least one embodiment of the present invention, the key rotation, for example, as illustrated in FIG. 9D, is performed in the bridge 672, in particular, in the scrambling/descrambling unit 676. The DRM server 680 of FIG. 9F may send or receive information via physical interfaces 674 or 678. The DRM server may also provide messages to control the operations of the key-rotation unit 676. In general, a bridge may include more or less components than those illustrated in the figure. For example, a bridge may include a tuner, a transcoder, a physical interface, a network communication interface, a cable, a storage device, etc. In some embodiments of the present invention, the software code that might be used for key rotation, for example, at 676, is obfuscated.

Referring now to FIG. 9G, an exemplary bridging process is presented in accordance with an embodiment of the present invention. More specifically, the figure illustrates a method for processing encrypted messages, for example, those encrypted (e.g., overscrambled) according to the method shown in FIG. 9A. The messages 596, 606, and 608 of FIG. 9A correspond to the messages 692, 704, and 694 of FIG. 9G, respectively. Even though it is not explicitly shown in the figure, the digital media content 692 in this example is protected by an “outer” or “global” digital rights management system (e.g., “A”). The overscrambled content 692 is partially descrambled, at 700, to generate a singly scrambled content 702 which may be put under the protection of another (“inner” or “local”) DRM system (e.g., “B”). As illustrated in the figure, three pertinent messages, 692, 694, and 704, are received first by a bridge. The delivered digital media content 692 has been encrypted or overscrambled by two control words. The control word 698 is associated with a DRM system “A”. According to this exemplary method, the encrypted control word 694 is first decrypted using the service key 696, which is associated with the global DRM system “A”, and the plaintext control word 698 is recovered. This control word 698 is then used to descramble, 700, the delivered digital media content 692 to generate a singly scrambled content 702 (which corresponds to content 588 in FIG. 9A). In some embodiments, the control word 704 encrypted with service key 696 is “key-rotated”, as indicated by operation 716 in the figure, to produce the control word 706 now encrypted with a different service key 708, which is associated with the local DRM system “B”. In certain embodiments, the first descrambling of the content, 700, and the key rotation, 716, is performed at a bridge. In certain embodiments of the present invention, this pair of encrypted messages, 702 and 706, may be stored in a storage unit for later processing. In certain other embodiments, one or both messages may be decrypted first before storage.

FIG. 9H shows another exemplary process according to an embodiment of the present invention. The figure illustrates a method for processing encrypted messages, for example, at a bridge and/or at a client, similar to the process shown in FIG. 9G. Even though it is not explicitly shown in the figure, there are involved two digital rights management systems (e.g., “A” and “B”), which use possibly different encryption/scrambling algorithms. The overscrambled content 692 is descrambled twice, at 700 and at 712, and eventually a clear content 714 is produced according to this method. As illustrated in the figure, three pertinent messages, 692, 694, and 704, are received first by a client, or a bridge. In some embodiments, these encrypted messages and the scrambled content may be delivered at the same time, e.g., during the time of initial distribution for playback. Or, in certain other embodiments, the scrambled content is delivered first and the necessary keys may be distributed later, for example, at the time of playback. The delivered digital media content 692 has been encrypted by two control words. The control word 698 is associated with a DRM system “A”, as shown in FIG. 9G, and the control word 710 is associated with a DRM system “B”, as shown in FIG. 9H. According to this exemplary method, the encrypted control word 694 is first decrypted and the decrypted control word is then used to descramble, 700, the delivered digital media content 692 to generate a singly scrambled content 702. The control word 704 encrypted with the “global” service key is typically “key-rotated”, as indicated by 716 in the figure, to produce the control word 706 now encrypted with the “local” service key, which is associated with the DRM system “B”. In certain embodiments, the first descrambling of the content, 700, and the key rotation, 716, is performed at a bridge, as indicate by two dashed lines 718 and 720 in FIG. 9H, which represent the boundaries of the bridge such that the operations 716 and 700 between those lines are done at the bridge. It should be noted that the new encrypted control word 706 and the singly scrambled content 702 are now under the protection of the DRM system “B” only. In certain embodiments of the present invention, this pair of encrypted messages may be stored in a local storage unit or transmitted to a client device. In certain other embodiments, one or both messages may be decrypted first before storage. According to the exemplary process illustrated in the figure, the encrypted control word 706 is next decrypted using the local service key (e.g., at a client device shown below the line 720, which represents the boundary between the bridge and the client). The plaintext control word 710 is then used to further descramble, 712, the scrambled content 702 to produce the cleartext digital media content 714. In certain embodiments, further decoding or processing (e.g., decoding of content in MPEG-2) may be required before the cleartext content is recovered.

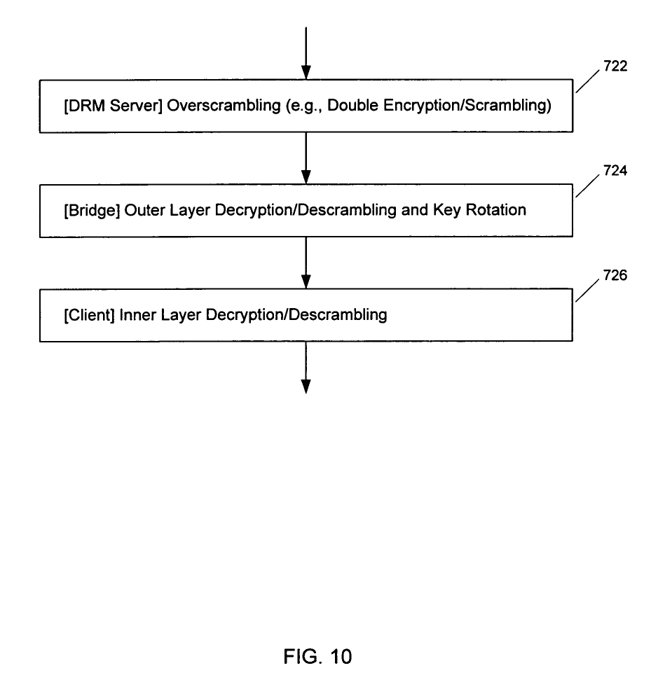

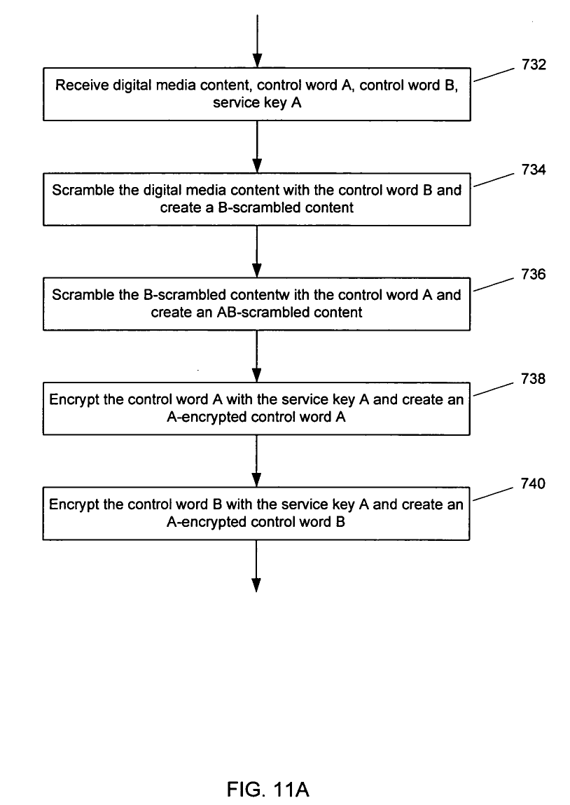

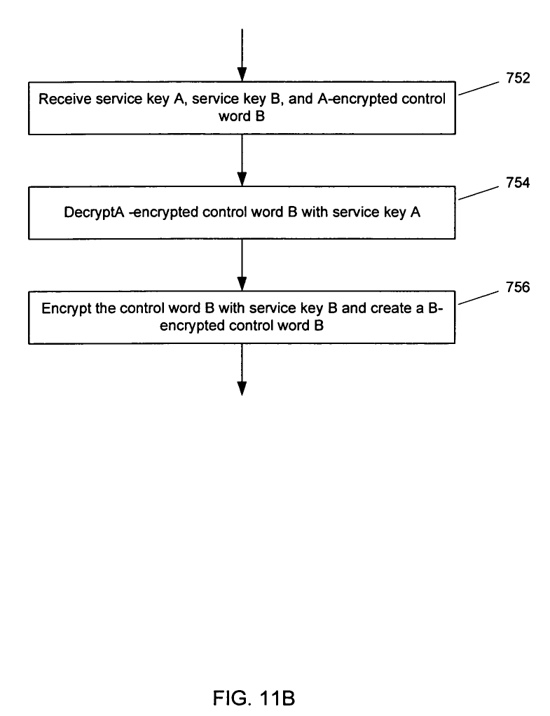

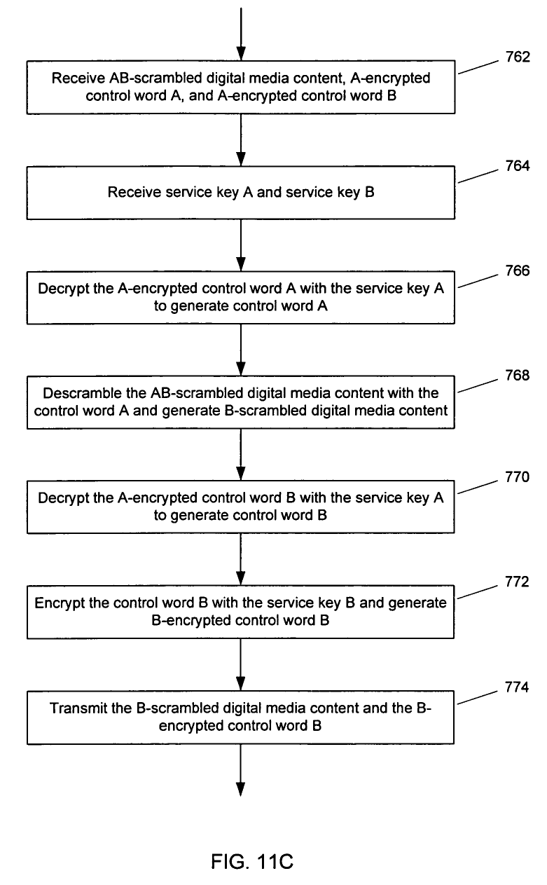

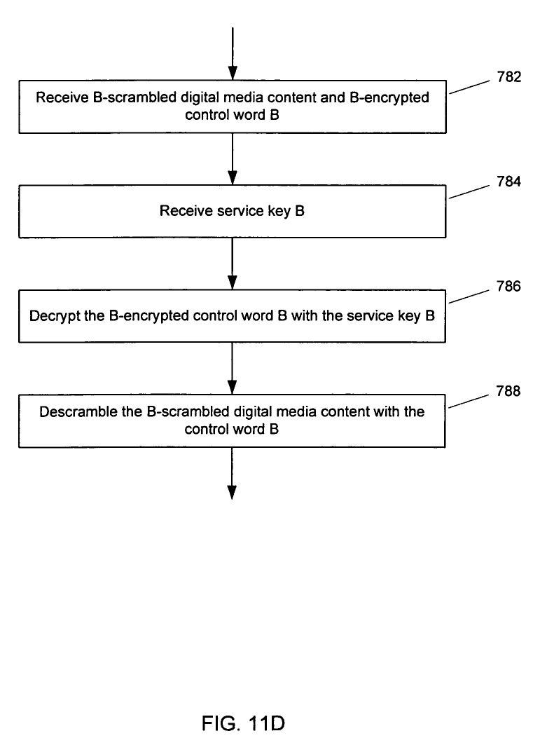

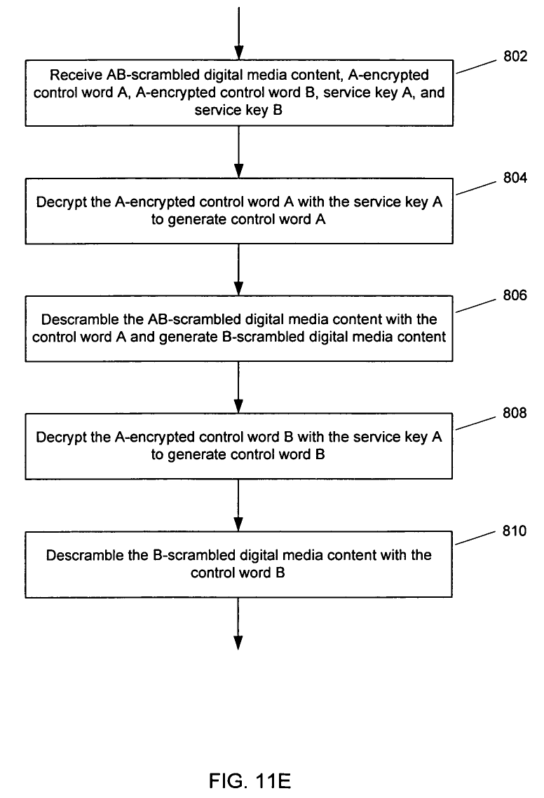

Various exemplary methods according to embodiments of the present invention are now shown in FIGS. 10 and 11A-11E as flow diagrams. FIG. 10 illustrates an overall process according to embodiments of the present invention. The flow chart shows three operations performed, possibly, by three separate entities, a DRM server, a bridge, and a client. According to the process shown in the flow chart, a DRM server performs the scrambling/encryption, at 722, for example, as shown in FIG. 9A. A bridge then performs the operations including key rotation, at 724, for example, as shown in FIG. 9G. The transformed messages are then processed by a client, at 726, for example, as illustrated at the bottom (below line 720) of FIG. 9H. In some embodiments, the client of block 726 may be under the protection of a DRM system different from the DRM system of block 722. In certain cases, the overscrambled/encrypted messages at 722 may be “compatible” with many different DRM systems of 726 depending on the implementation of bridges and/or clients.

With reference to FIG. 11A, the flow chart illustrates an exemplary process for encrypting/scrambling digital media according to an embodiment of the present invention. As before, this exemplary method is described in the context of protecting digital media using two digital rights management (DRM) systems, denoted as “A” and “B” in the flow chart. A service key(s) and a control word(s) are associated with each DRM system. The exemplary process shown in the figure starts, at 732, by receiving digital media content, an encryption key CW_{A} associated with the DRM system A, an encryption key CW_{B} associated with the DRM system B, and another encryption key SK_{A} associated with the DRM system A. The digital media is encrypted, at 734, using the encryption key CW_{B} and a first scrambled content is created, which is encrypted again, at 736, using the encryption key CW_{A}. In certain embodiments, the scrambling at 734 and the scrambling at 736 use different encryption algorithms. For example, the block cipher mode, AES+CBC or 3DES+ECB, may be used for the first scrambling, 734, whereas the AES+CTR mode (or AES+ECB, 3DES+CBC, etc) may be used for the second scrambling, 736. In certain embodiments, both the encryption key CW_{A} and the encryption key CW_{B} are encrypted with the same key SK_{A}, at 738 and 740, and two ECM messages are created. These encrypted keys and the AB-scrambled digital media content are then delivered to a client. In some embodiments, these encrypted messages are delivered at the same time, e.g., during the time of initial distribution for playback. In other embodiments, the scrambled content is delivered first and the necessary keys are distributed later when requested.

Now turning to FIG. 11B, a flow chart illustrating a key rotation process according to an embodiment of the present invention is shown. The exemplary method comprises rotating keys at a bridge between a first digital rights management system and a second digital rights management system, “A” and “B”, where the first and second DRM systems have a first and second service keys, SK_{A} and SK_{B}, respectively. In some embodiments, the first and second service keys are delivered to the bridge prior to, or concurrently with, the delivery of digital media content and/or the encrypted messages. According to the embodiment shown in the figure, a method for key rotation is performed by first receiving, at 752, the first service key SK_{A} associated with the DRM system A, the second service key SK_{B} associated with the DRM system B, and an encrypted control word CW_{B} associated with the DRM system B. The control word CW_{B} has been encrypted with the first service key SK_{A}. Next, the encrypted control word CW_{B} is decrypted, at 754, using the first service key SK_{A}, to obtain the plaintext control word CW_{B}. Then the control word CW_{B} is encrypted, at 756, with the second service key SK_{B}. This process results in a “key-rotated” ECM message, for example, 662 of FIG. 9D.

A flow chart of FIG. 11C illustrates an exemplary process at a bridge according to an embodiment of the present invention. The exemplary process comprises key rotation (e.g., as shown in FIG. 11B) as well as (single) descrambling of overscrambled digital media content. As before, the bridge connects a first (“outer” or “global”) digital rights management system with a second (“inner” or “local”) digital rights management system, “A” and “B”, where the first and second DRM systems have a first and second service keys, SK_{A} and SK_{B}, respectively. The process of FIG. 11C starts by first receiving, at 762, an overscrambled digital media content and encrypted control words CW_{A} and CW_{B} associated with the DRM systems A and B, respectively. Both control words have been encrypted with a first service key SK_{A} associated with the DRM system A. Next, at 764, the first service key SK_{A} is received. At 766, then, the encrypted control word CW_{A} is decrypted using the first service key SK_{A} to obtain the plaintext control word CW_{A}, which is in turn used, at 768, to descramble the overscrambled digital media content. This operation generates a singly scrambled media content scrambled with the second control word CW_{B}. Next, the encrypted control word CW_{B} is decrypted, at 770, using the first service key SK_{A}, to obtain the plaintext control word CW_{B}. Then the control word CW_{B} is encrypted, at 756, with a second service key SK_{B}. These two operations 770 and 772 comprise the key rotation operation, for example, as illustrated in FIG. 11B. In the exemplary process illustrated with reference to FIG. 11C, the digital media content scrambled with the control word CW_{B} is delivered to a client along with the key CW_{B} encrypted with the second service key SK_{B}, which is managed by the second DRM system B, as indicated in block 774. In some embodiments, these encrypted messages and the scrambled content are delivered at the same time, e.g., during the time of initial distribution. In certain other embodiments, the scrambled content is delivered first and the necessary keys may be delivered later, for example, in response to requests from the client.

In some embodiments, a method is provided for decrypting/descrambling digital media content that is protected by a digital rights management system. An exemplary process is illustrated in FIG. 11D as a flow chart. In some embodiments, this can be practiced in conjunction with various encryption/scrambling schemes, for example, as illustrated in FIG. 11A, and bridging operations, for example, as illustrated in FIG. 11C. The method for descrambling digital media content shown in FIG. 11D begins by receiving, at 782 and 784, a scrambled digital media content encrypted with a control word CW_{B}, the encrypted control word CW_{B} encrypted with a service key SK_{B}, and the service key SK_{B}. Then the encrypted control word is decrypted using the service key, at 786, to obtain the plaintext control word CW_{B}. The decrypted control word is then used, at 788, to descramble the received digital media content. In some embodiments, the encrypted messages and the scrambled content may be delivered at the same time, e.g., during the time of initial distribution for storage. Or, in certain other embodiments, the scrambled content is delivered first and the necessary keys may be distributed later, for example, at the time of playback.

In some embodiments, a method is provided for bridging and/or decrypting/descrambling of digital media that is protected by multiple DRM systems. According to an embodiment, the process comprises: (a) Receiving, by a client, scrambled digital media content which is encrypted by a first and second control words, where the first control word is associated with a first DRM system and the second control word is associated with a second DRM system, (b) Receiving the first and second control words encrypted with a service key which is associated with the first DRM system, (c) Decrypting the control words with the service key, and (d) Descrambling the digital media content using the decrypted control words. This exemplary process is illustrated in FIG. 11E as a flow chart. In some embodiments, this can be practiced in conjunction with various encryption/scrambling schemes, for example, as illustrated in FIG. 11A. The method for descrambling digital media content shown in FIG. 11E begins by receiving, at 802, a service key SK_{A} associated with a DRM system A, a control word CW_{A} encrypted with the service key SK_{A}, and a scrambled (or, overscrambled) digital media content encrypted with both control words CW_{A} and CW_{B}, which are associated with DRM systems A and B, respectively. For example, these messages may correspond to 696, 694, and 692 of FIG. 9G. In the example, the content 692 has been scrambled with the control word CW_{B} first and then with the control word CW_{A}. In block 804 of FIG. 11E, the encrypted control word CW_{A} is decrypted with the service key SK_{A}, and the plaintext control word CW_{A} is recovered. The decrypted control word CW_{A} is then used to descramble, at 806, the received digital media content. Then, in block 808, a control word CW_{B} encrypted with the service key SK_{B} is received. The service key SK_{B} is associated with the DRM system B. In some embodiments, the control word CW_{B} encrypted with the service key SK_{A} is first received, which is then key-rotated to produce the control word CW_{B} encrypted with the service key SK_{B}, for example, using a method illustrated in FIG. 11B. In certain embodiments, the digital media content scrambled with the control word CW_{B}, recovered at block 806 of FIG. 11E, and the key-rotated control word CW_{B} encrypted with the service key SK_{B}, received at 808, are stored at client device for future use. This pair of data/messages is under the protection of the DRM system B. In the exemplary process illustrated in the flow chart, the control word (e.g., ECM) is first decrypted, at 808, using the service key SK_{B}. Then the plaintext control word CW_{B} is used, at 810, to decrypt the scrambled media content. In some embodiments, encryption and decryption operations may use different encryption and decryption keys.

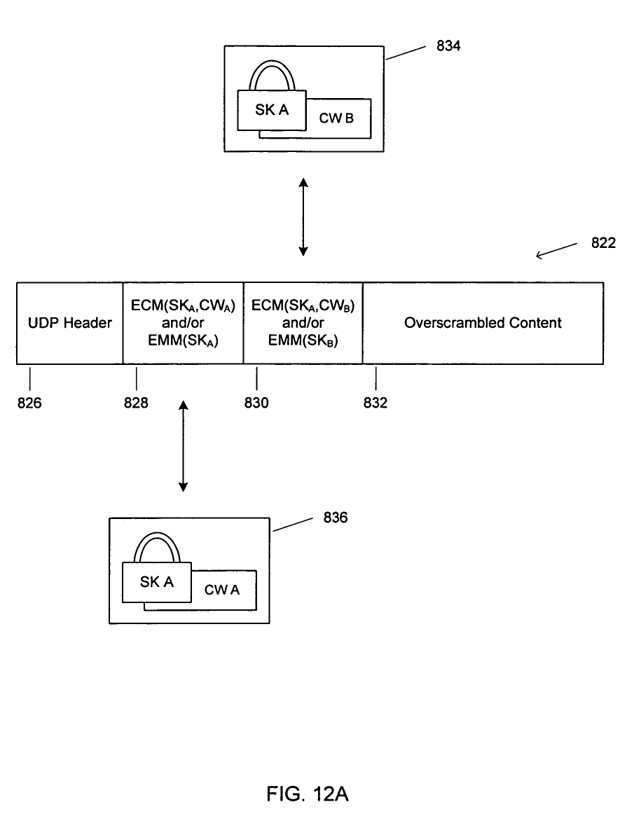

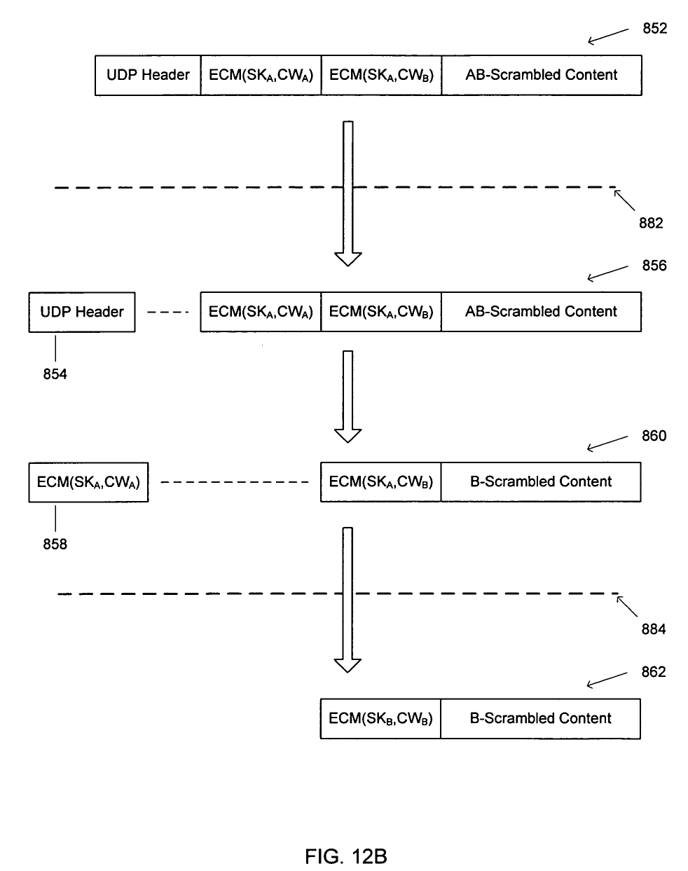

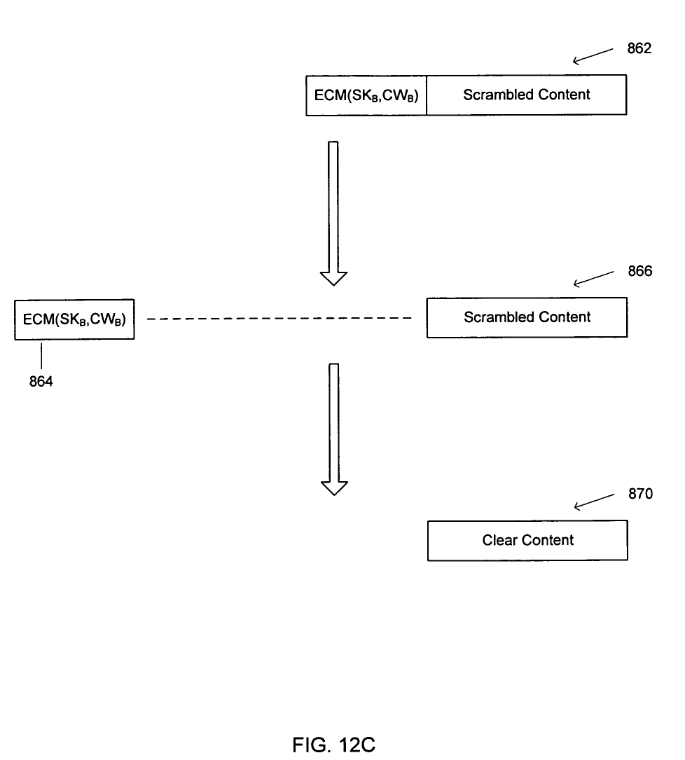

Referring now to FIGS. 12A, 12B, and 12C, exemplary data packets according to at least one embodiment of the present invention are shown. In some embodiments, content protection systems such as DTCP (Digital Transmission Content Protection) are used for transmitting various messages including the digital media content. The DTCP standard uses a cryptographic protocol for protecting digital media content from illegal copying, intercepting and tampering in IP-based networks. The particular examples shown in FIGS. 12 are based on the UDP/IP protocol, as indicated by UDP headers in schematic representations of data packets.

FIG. 12A illustrates an exemplary UDP packet 822 according to an embodiment of the present invention. The data packet is “constructed” from right to left. The packet 822 contains scrambled, or overscrambled, digital media content 832 and its “header” 830. In some embodiments, this may be in the form of a DTCP packet. The header 830 contains an ECM in this example, which comprises a control word CW_{B} encrypted with a service key SK_{A}, represented by 834 in the figure. Note that the control word CW_{B} and the service key SK_{A} are associated with different DRM systems (“B” and “A”) in this example. This has been illustrated, for example, with reference to the embodiments shown in FIG. 9A or FIG. 11A. The header 830 may contain relevant EMM in some implementations. EMMs may be delivered separately from the ECM and the media content in some other implementations. In certain embodiments, the content 822 is scrambled with the control word CW_{B} and scrambled again (overscrambled) with another control word CW_{A}. Then, another “header” 828 is added, which comprises another ECM, the control word CW_{A} encrypted with the service key SK_{A}. The outer-layer ECM is shown as 836 in the figure. As stated earlier, this header 828 may contain relevant EMM also. Even though it is not explicit in the drawing, its “payload”, i.e., 830 and 832, may be further encoded, encrypted, or otherwise transformed. In particular, the pair 830 and 832 may no longer occupy two separate regions in the data packet. The header, 828, and its payload, 830 and 832, are then further encoded according to various network transmission protocols (e.g., various stacks in OSI). The figure shows a UDP header 826 as an example of a network transport header (other examples might include TCP/IP headers, etc.). As stated, its payload, 828, 830 and 832, may be further encoded, encrypted, or otherwise transformed.

FIG. 12B illustrates an exemplary process for “parsing” a UDP packet used for transmission of digital media in certain embodiments of the present invention. The data packet 852 may have been constructed according to an embodiment of the present invention, for example, as illustrated in FIG. 9A or FIG. 11A, or in FIG. 12A as 822. The exemplary process shown in FIG. 12B may be used, among other things, for bridging two different DRM systems or for descrambling the digital media content in a client device. The received data packet 852 is first parsed according to UDP/IP protocol and its header 854 is discarded (after necessary processing). The payload 856 is then decoded and/or decrypted. The (decoded) UDP payload 856 contains a header 858 and a body 860. This is then further processed into the two parts, 858 and 860. In some embodiments, proper authorization from a DRM system (i.e., DRM system “A” in this illustration) may be required in order to be able to process the UDP payload 856. Then, the body 860 is further processed. In certain embodiments, the body part 860 may have been encrypted with a control word (e.g., the control word CW_{A} in the illustration), and it may need to be decrypted first before further processing. According to at least one embodiment of the present invention, proper authorization from a DRM system needs to be obtained (e.g., as a form of an EMM containing a service key SK_{A}) before it can be decrypted. In some cases, the content may be partially decrypted, for example, using the recovered key CW_{A}. In the exemplary process shown in the figure, the encrypted data 860 is transformed according to a key-rotation operation, as illustrated earlier with regards to FIG. 9D or FIG. 11B. The result is shown as 862 in FIG. 12B, where the media content is no longer overscrambled. The “bridge” is indicated in the figure as two dashed lines 882 and 884, with 852 as input and 862 as output. In certain embodiments, the output packet data 862 may be further processed. In certain other embodiments, it may be recorded in a scrambled form and/or transmitted to one or more clients.

This is further illustrated in FIG. 12C. As shown in the figure, the encrypted data 862 is decoded and divided into two parts 864 and 866. Then, the header 864 is decrypted and the second ECM is recovered. It should be noted that the ECM in the header 864 and the scrambled content 866 are under the protection of the second DRM system (“B” in this example). In some embodiments, this pair of the ECM and the scrambled content may be stored (e.g., in a client device) to be protected by the DRM system. In certain embodiments, the content 866 is first descrambled to obtain the clear content 870 before it is recorded. The descrambled content 870 may then be presented to the user for viewing or for other purposes.

Thus, systems, methods, and apparatuses for managing digital rights in digital media delivery have been provided. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense

What is claimed is:

1. A method for encrypting digital media at a first location, the method comprising:
generating a first encrypted digital media content by performing encryption of a digital media content with a first encryption key according to a first encryption scheme;
generating a second encrypted digital media content by performing encryption of said first encrypted digital media content with a second encryption key according to a second encryption scheme;
generating a first encrypted message, said first encrypted message comprising said first encryption key encrypted with a third encryption key; and
generating a second encrypted message, said second encrypted message comprising said second encryption key encrypted with said third encryption key.

2. The method of claim 1, wherein:
said first encryption scheme is different from said second encryption scheme.

3. The method of claim 1, wherein:
said first encryption scheme comprises at least one of the following encryption algorithms: (a) DES, (b) 3DES, (c) AES, (d) M2, (e) M6, or (f) DVB-CSA; and
said second encryption scheme comprises at least one of the following encryption algorithms: (a) DES, (b) 3DES, (c) AES, (d) M2, (e) M6, or (f) DVB-CSA.

4. The method of claim 1, wherein:
said first encryption key is associated with a first digital rights management system;
said second encryption key is associated with a second digital rights management system; and
said third encryption key is associated with said second digital rights management system.

5. The method of claim 4, wherein:
said first encryption key is a first control word associated with said first digital rights management system;
said second encryption key is a second control word associated with said second digital rights management system; and
said third encryption key is a service key associated with said second digital rights management system.

6. The method of claim 1, the method further comprising:
sending to a second location said second encrypted digital media content.

7. The method of claim 6, the method further comprising:
sending to said second location, in response to a request from said second location, said first encrypted message and said second encrypted message.

8. A method, to be used in a bridge between a first digital rights management system and a second digital rights management system, the method comprising:
receiving a scrambled digital media content, said scrambled digital media content being encrypted with a first control word and a second control word;
receiving a first encrypted message, said first encrypted message comprising said second control word encrypted with a first service key associated with the first digital rights management system; and
generating a second encrypted message, said second encrypted message comprising said second control word encrypted with a second service key associated with the second digital rights management system.

9. The method of claim 8, wherein:
said scrambled digital media content comprises data encrypted with said first control word, wherein said data is generated by encrypting a digital media content with said second control word.

10. The method of claim 8, wherein said generating comprises:
decrypting said first encrypted message using said first service key; and
generating said second encrypted message by encrypting said second control word with the second service key.

11. The method of claim 8, the method further comprising:
receiving the first service key from the first digital rights management system; and
obtaining the second service key for the second digital rights management system.

12. The method of claim 11, wherein:
said obtaining is performed by receiving at the bridge the second service key through a communication medium.

13. The method of claim 11, wherein:
said obtaining is performed by generating at the bridge the second service key.

14. The method of claim 8, the method further comprising:
performing at least one of:
(a) sending said scrambled digital media content and said second encrypted message; or
(b) storing said scrambled digital media content and said second encrypted message.

15. A method, to be used in a digital rights management system, for decrypting an encrypted digital media, the method comprising:
receiving an encrypted digital media content, the encrypted digital media content comprising encrypted data, said encrypted data being encrypted with a first encryption key according to a first encryption scheme, wherein said encrypted data is created by encrypting a digital media content with a second encryption key according to a second encryption scheme;
receiving a first encrypted message, said first encrypted message comprising a first decryption key encrypted with a third encryption key, said first decryption key corresponding to said first encryption key;
receiving a third decryption key corresponding to said third encryption key;
generating the first decryption key by decrypting said first encrypted message using said third decryption key; and
performing decryption of said encrypted digital media content using at least said first decryption key.

16. The method of claim 15, wherein:
said first encryption scheme is different from said second encryption scheme.

17. The method of claim 15, wherein:
said first decryption key is substantially the same as said first encryption key, and said third decryption key is substantially the same as said third encryption key.

18. The method of claim 15, further comprising:
receiving a second encrypted message, said second encrypted message comprising a second decryption key encrypted with said third encryption key, said second decryption key corresponding to said second encryption key;
generating the second decryption key by decrypting said second encrypted message using said third decryption key; and
performing decryption of said encrypted data using at least said second decryption key.

19. The method of claim 15, further comprising:
receiving a second encrypted message, said second encrypted message comprising a second decryption key encrypted with said third encryption key, said second decryption key corresponding to said second encryption key;
decrypting said second encrypted message using said third decryption key;
obtaining a fourth encryption key; and
encrypting said second decryption key with said fourth encryption key.

20. The method of claim 19, wherein:
said obtaining is performed by receiving said fourth encryption key through a communication medium.

21. The method of claim 19, wherein:
said obtaining is performed by generating said fourth encryption key.

22. The method of claim 15, further comprising:
receiving a third encrypted message, said third encrypted message comprising a second decryption key encrypted with a fourth encryption key, said second decryption key corresponding to said second encryption key;
receiving a fourth decryption key corresponding to said fourth encryption key;
generating the second decryption key by decrypting said third encrypted message using said fourth decryption key; and
performing decryption of said encrypted data using at least said second decryption key.

23. An apparatus for encrypting digital media, the apparatus comprising:
a processor;
a memory coupled with said processor, said memory having contained therein sequences of instructions which, when executed by said processor, cause said processor to perform:
generating a first encrypted digital media content by performing encryption of a digital media content with a first encryption key;
generating a second encrypted digital media content by performing encryption of said first encrypted digital media content with a second encryption key;
generating a first encrypted message, said first encrypted message comprising said first encryption key encrypted with a third encryption key; and
generating a second encrypted message, said second encrypted message comprising said second encryption key encrypted with said third encryption key.

24. The apparatus of claim 23, wherein:
said first encryption scheme is different from said second encryption scheme.

25. The apparatus of claim 23, wherein:
said first encryption key is a first control word associated with a first digital rights management system;
said second encryption key is a second control word associated with a second digital rights management system; and
said third encryption key is a service key associated with said second digital rights management system.

26. An apparatus, to be used in a bridge between a first digital rights management system and a second digital right management system, the apparatus comprising:
a processor;
a memory coupled with said processor, said memory having contained therein sequences of instructions which, when executed by said processor, cause said processor to perform:
receiving a scrambled digital media content, said scrambled digital media content being encrypted with a first control word and a second control word;
receiving a first encrypted message, said first encrypted message comprising said second control word encrypted with a first service key associated with the first digital rights management system; and
generating a second encrypted message, said second encrypted message comprising said second control word encrypted with a second service key associated with the second digital rights management system.

27. The apparatus of claim 26, wherein:
said scrambled digital media content comprises data encrypted with said first control word, wherein said data is generated by encrypting a digital media content with said second control word.

28. The apparatus of claim 26, wherein said generating comprises:
decrypting said first encrypted message using said first service key; and
generating said second encrypted message by encrypting said second control word with the second service key.

29. An apparatus, to be used in a digital rights management system, for decrypting an encrypted digital media, the apparatus comprising:
a processor;
a memory coupled with said processor, said memory having contained therein sequences of instructions which, when executed by said processor, cause said processor to perform a method, the method comprising:
receiving an encrypted digital media content, the encrypted digital media content comprising encrypted data, said encrypted data being encrypted with a first encryption key according to a first encryption scheme, wherein said encrypted data is created by encrypting a digital media content with a second encryption key according to a second encryption scheme;
receiving a first encrypted message, said first encrypted message comprising a first decryption key encrypted with a third encryption key, said first decryption key corresponding to said first encryption key;
receiving a third decryption key corresponding to said third encryption key;
generating the first decryption key by decrypting said first encrypted message using said third decryption key; and
performing decryption of said encrypted digital media content using at least said first decryption key.

30. The apparatus of claim 29, wherein the method further comprising:
receiving a second encrypted message, said second encrypted message comprising a second decryption key encrypted with said third encryption key, said second decryption key corresponding to said second encryption key;
generating the second decryption key by decrypting said second encrypted message using said third decryption key; and
performing decryption of said encrypted data using at least said second decryption key.

31. The apparatus of claim 29, wherein the method further comprising:
receiving a second encrypted message, said second encrypted message comprising a second decryption key encrypted with said third encryption key, said second decryption key corresponding to said second encryption key;
decrypting said second encrypted message using said third decryption key;
obtaining a fourth encryption key; and
encrypting said second decryption key with said fourth encryption key.

32. The method of claim 31, wherein:
said obtaining is performed by receiving said fourth encryption key through a communication medium.

33. The method of claim 31, wherein:
said obtaining is performed by generating said fourth encryption key.

34. The apparatus of claim 29, wherein the method further comprising:
receiving a third encrypted message, said third encrypted message comprising a second decryption key encrypted with a fourth encryption key, said second decryption key corresponding to said second encryption key;
receiving a fourth decryption key corresponding to said fourth encryption key;
generating the second decryption key by decrypting said third encrypted message using said fourth decryption key; and
performing decryption of said encrypted data using at least said second decryption key.

35. A machine readable medium, the machine readable medium containing machine executable program instructions for encrypting digital media which, when executed by a data processing system, causes the data processing system to perform a method comprising:
generating a first encrypted digital media content by performing encryption of a digital media content with a first encryption key;
generating a second encrypted digital media content by performing encryption of said first encrypted digital media content with a second encryption key;
generating a first encrypted message, said first encrypted message comprising said first encryption key encrypted with a third encryption key; and
generating a second encrypted message, said second encrypted message comprising said second encryption key encrypted with said third encryption key.

36. The machine readable medium of claim 35, wherein:
said first encryption scheme is different from said second encryption scheme.

37. The machine readable medium of claim 35, wherein:
said first encryption key is a first control word associated with a first digital rights management system;
said second encryption key is a second control word associated with a second digital rights management system; and
said third encryption key is a service key associated with said second digital rights management system.

38. A machine readable medium containing machine executable program instructions which, when executed by a data processing system, cause the data processing system to perform a method, the method to be used in a bridge between a first digital rights management system and a second digital right management system, the method comprising:
receiving a scrambled digital media content, said scrambled digital media content being encrypted with a first control word and a second control word;
receiving a first encrypted message, said first encrypted message comprising said second control word encrypted with a first service key associated with the first digital rights management system; and
generating a second encrypted message, said second encrypted message comprising said second control word encrypted with a second service key associated with the second digital rights management system.

39. The machine readable medium of claim 38, wherein:
said scrambled digital media content comprises data encrypted with said first control word, wherein said data is generated by encrypting a digital media content with said second control word.

40. The machine readable medium of claim 38, wherein said generating comprises:
decrypting said first encrypted message using said first service key; and
generating said second encrypted message by encrypting said second control word with the second service key.

41. The machine readable medium of claim 38, wherein:
the machine executable program instructions are obfuscated.

42. A machine readable medium containing machine executable program instructions which, when executed by a data processing system, cause the data processing system to perform a method, the method to be used in a digital rights management system, for decrypting an encrypted digital media, the method performing:
receiving an encrypted digital media content, the encrypted digital media content comprising encrypted data, said encrypted data being encrypted with a first encryption key according to a first encryption scheme, wherein said encrypted data is created by encrypting a digital media content with a second encryption key according to a second encryption scheme;
receiving a first encrypted message, said first encrypted message comprising a first decryption key encrypted with a third encryption key, said first decryption key corresponding to said first encryption key;
receiving a third decryption key corresponding to said third encryption key;
generating the first decryption key by decrypting said first encrypted message using said third decryption key; and
performing decryption of said encrypted digital media content using at least said first decryption key.

43. The machine readable medium of claim 42, wherein the method further comprising:
receiving a second encrypted message, said second encrypted message comprising a second decryption key encrypted with said third encryption key, said second decryption key corresponding to said second encryption key;
generating the second decryption key by decrypting said second encrypted message using said third decryption key; and
performing decryption of said encrypted data using at least said second decryption key.

44. The machine readable medium of claim 42, wherein the method further comprising:
receiving a second encrypted message, said second encrypted message comprising a second decryption key encrypted with said third encryption key, said second decryption key corresponding to said second encryption key;
decrypting said second encrypted message using said third decryption key;
obtaining a fourth encryption key; and
encrypting said second decryption key with said fourth encryption key.

45. The method of claim 44, wherein:
said obtaining is performed by receiving said fourth encryption key through a communication medium.

46. The method of claim 44, wherein:
said obtaining is performed by generating said fourth encryption key.

47. The machine readable medium of claim 42, wherein the method further comprising:
receiving a third encrypted message, said third encrypted message comprising a second decryption key encrypted with a fourth encryption key, said second decryption key corresponding to said second encryption key;
receiving a fourth decryption key corresponding to said fourth encryption key;
generating the second decryption key by decrypting said third encrypted message using said fourth decryption key; and
performing decryption of said encrypted data using at least said second decryption key.

48. The machine readable medium of claim 42, wherein:
the machine executable program instructions are obfuscated.
